(19) United States
(12) Patent Application Publication
(10) Pub. No.: US 2025/0150183 A1
(43) Pub. Date: May 8, 2025

(54) SYSTEMS AND METHODS FOR INTERFERENCE MEASUREMENT FOR NETWORK NODES

(71) Applicant: ZTE CORPORATION, Shenzhen (CN)

(72) Inventors: Ziyang LI, Shenzhen (CN); Nan ZHANG, Shenzhen (CN); Wei CAO, Shenzhen (CN); Hanqing XU, Shenzhen (CN); Shuang ZHENG, Shenzhen (CN)

(73) Assignee: ZTE CORPORATION, Shenzhen (CN)

(21) Appl. No.: 19/015,250

(22) Filed: Jan. 9, 2025

Related U.S. Application Data
(63) Continuation of application No. PCT/CN2023/082062, filed on Mar. 17, 2023.

(51) Int. Cl. H04B 17/309; H04W 24/10; H04W 52/36; H04W 72/20

(52) U.S. Cl. CPC H04B 17/346; H04W 24/10; H04W 52/367; H04W 72/20

(57) ABSTRACT

Presented are systems and methods for measuring interference for network nodes. A network node can determine a status of interference experienced at the network node. The network node can send an indication of the status of the interference to a wireless communication node.

### CROSS-REFERENCE TO RELATED APPLICATION

This application claims the benefit of priority under 35 U.S.C. § 120 as a continuation of PCT Patent Application No. PCT/CN2023/082062, filed on Mar. 17, 2023, the disclosure of which is incorporated herein by reference in its entirety.

### TECHNICAL FIELD

The disclosure relates generally to wireless communications, including but not limited to systems and methods for measuring interference for network nodes.

### BACKGROUND

Coverage is a fundamental aspect of cellular network deployments. Mobile operators rely on different types of network nodes to offer blanket coverage in their deployments. As a result, new types of network nodes have been considered to increase the flexibility of mobile operators for their network deployments. For example, certain systems or architecture introduce integrated access and backhaul (IAB), which may be enhanced in certain other systems, as a new type of network node not requiring a wired backhaul. Another type of network node is the RF repeater which simply amplify-and-forward any signal that they receive. RF repeaters have seen a wide range of deployments in 2G, 3G and 4G to supplement the coverage provided by regular full-stack cells.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A network node (e.g., smart node (SN)) can determine a status of interference experienced at the network node. The network node can send an indication of the status of the interference to a wireless communication node (e.g., base station (BS), Gnb, or transmission and reception point (TRP)).

In some implementations, the interference may be experienced by at least one of: the control link between the wireless communication node and the network node; the backhaul link between the wireless communication node and the network node; and/or the access link between the wireless communication device and the network node. In some implementations, determining the status of the interference can comprise at least one of: measuring, by the network node, a first energy value (P1) at an input of the network node, when a first link to the input is activated, and a second link from an output of the network node is deactivated; measuring, by the network node, a second energy value (P2) at the input of the network node, when the first link to the input is activated, and the second link is activated; or determining, by the network node, a value of the interference as a function of at least one of: P1, P2, or α, where α is a positive value configured by the wireless communication node.

In some implementations, determining the status of the interference can comprise at least one of: measuring, by the network node, a respective energy value at an input of the network node, for each of a plurality of power values when a first link to the input is activated and a second link from an output of the network node is activated; and determining, by the network node, a value of the interference as a function of at least one of: one or more of the respective energy values, one or more of the plurality of power values, or α, where α is a positive value configured by the wireless communication node.

In some implementations, at least one of: each of the plurality of power values can refer to at least one of: an amplifying again, a transmission power, or a power offset, for the network node. In some implementations, the determining the status of the interference can comprise at least one of: measuring, by the network node, a respective energy value at an input of the network node, in each of a plurality of time windows when a first link to the input is activated and a second link from an output of the network node is activated; and determining, by the network node, a value of the interference as a function of at least one of: one or more of the respective energy values, or α, where α is a positive value configured by the wireless communication node.

In some implementations, the plurality of time windows can include at least one of: a first time window that is defined from a first time instance to a second time instance, wherein the second time instance is T1 added to the first time instance; a second time window that is defined from the second time instance to a third time instance, wherein the third time instance is T2 added to the first time instance; or a third time window that is defined from the third time instance to a fourth time instance, wherein the fourth time instance is T1 added to the third time instance.

In some implementations, the values of T0, T1, and T2 are determined according to at least one of: the capability of the network node; duration of the measurement; time domain resource of reference signal; a predefined value; a parameter configured by the wireless communication node; the start time of the measurement; a predefined time instance; and/or a time instance triggered by the wireless communication device.

In some implementations, determining the status of the interference can comprise at least one of: measuring, by the network node, a first energy value (P1) of an input signal at an input of the network node, in a first frequency band of the input signal when a first link to the input is activated, and a second link from an output of the network node is activated; measuring, by the network node, a second energy value (P2) of the input signal at the input of the network node, in a second frequency band of an output signal corresponding to the input signal, when the first link to the input is activated, and the second link is activated; or determining, by the network node, a value of the interference as a function of at least one of: P1, P2, or α, where α is a positive value configured by the wireless communication node.

In some implementations, determining the status of the interference can comprise at least one of: measuring, by the network node, a first energy value (P1) of an input signal at an input of the network node, at a first polarization of the input signal when a first link to the input is activated, and a second link from an output of the network node is activated; measuring, by the network node, a second energy value (P2) of the input signal at the input of the network node, at a second polarization of an output signal corresponding to the input signal, when the first link to the input is activated, and the second link is activated; or determining, by the network node, a value of the interference as a function of at least one of: P1, P2, or α, where α is a positive value configured by the wireless communication node.

In some implementations, P1 and P2 may be measured for a specific input beam at the input and a specific output beam at the output. In some implementations, at least one of: each respective energy value can be measured for a respective input beam at the input and a respective output beam at the output, each respective input beam may be same as or different from another respective input beam, or each respective output beam may be same as or different from another respective output beam.

In some implementations, the first link or the second link can comprise at least one of: a first forwarding link from the wireless communication node to the network node; a second forwarding link from the network node to the wireless communication device; a third forwarding link from the network node to the wireless communication node; a fourth forwarding link from the wireless communication device to the network node; a first control link from the wireless communication node to the network node; and/or a second control link from the network node to the wireless communication node. In some implementations, the network node can receive at least one parameter for interference measurement from the wireless communication node. The network node can determine the status of the interference according to the at least one parameter for interference measurement.

In some implementations, the at least one parameter can comprise an indication of at least one of: a time domain resource, a frequency domain resource, at least one of: a transmission power, an amplifying gain, or a power offset, beam information, activation or deactivation information for at least one of a first link or a second link, polarization information, measurement direction, which comprises uplink, downlink, or both uplink and downlink, an indication for selection of a method for determining the status of the interference, reference signal type, measurement method type, cell information, or a threshold for a level of the interference.

In some implementations, selection of a method for determining the status of the interference may be explicitly or implicitly based at least on the at least one parameter. In some implementations, determining the status of the interference can comprise at least one of: measuring, by the network node, an energy value of all signals at an input of the network node; measuring, by the network node, an energy value of a specific signal at the input of the network node; and/or measuring, by the network node, a strength of noise at the input of the network node.

In some implementations, determining the status of the interference can comprise: measuring, by the network node, an energy value of an input signal at an input of the network node. The input signal can comprise at least one of: a synchronization signal block (SSB), a channel state information RS (CSI-RS), a downlink signal dedicated for the network node, a physical downlink control channel (PDCCH) signal, a physical downlink shared channel (PDSCH) signal, a sequence dedicated for the network node, an on-off keying sequence, a Zadoff-Chu (ZC) sequence, a pseudonoise (PN) sequence, a sounding reference signal (SRS), a physical uplink control channel (PUCCH) signal, a physical uplink shared channel (PUSCH) signal, an uplink signal dedicated for the network node, or a physical random access channel (PRACH) sequence.

In some implementations, determining the status of the interference can comprise: measuring, by the network node, an energy value of an input signal at an input of the network node, responsive to a triggering event. The triggering event can comprise at least one of: an event associated with establishment of radio resource control (RRC) connection, reception of a defined indication from the wireless communication node, reception of a defined indication from the wireless communication device, the network node detecting that a condition has been met, or the network node detecting an anomaly.

In some implementations, the network node can compare a value of the interference with at least one threshold. The at least one threshold can at least one of: comprise a respective threshold for each type or set of interference measurement, comprise a first threshold for downlink forwarding, and a second threshold for uplink forwarding, define a plurality of ranges for levels of the interference, be predefined, be indicated or configured by the wireless communication node, or be defined according to a capability of the network node.

In some implementations, the indication of the status of the interference sent to the wireless communication node can comprise at least one of: a value measured by the network node, multiple values measured by the network node, a value of the interference, calculated using at least one value measured by the network node, a level of the interference, determined according to a comparison between the value measured by the network node and a threshold, a level of the interference determined according to a comparison between the value of the interference and a threshold, an indication that the status of the interference is determined for or applies to: downlink forwarding, uplink forwarding, or both downlink forwarding and uplink forwarding, beam information according to the status of the interference, power information according to the status of the interference, or information about an action to be performed by the network node, after or responsive to: the status of the interference or a measurement by the network node. In some implementations, the indication may be sent to the wireless communication node in: uplink control information (UCI) via a transmission in physical uplink control channel (PUCCH) or physical uplink shared channel (PUSCH), medium access control control element (MAC CE) signaling via a transmission in PUSCH, or radio resource control (RRC) signaling via the transmission in PUSCH.

In some implementations, the network node can receive a message in response to the indication of the status of the interference from the wireless communication node. The message can comprise at least one of: a beam indication to configure beam index of the forwarding link, a power control indication to adjust, specific to or not specific to a beam, at least one of: an amplifying gain, transmission power of power offset of the network node, an indication to activate or deactivate the forwarding link, or a time domain resource associated with the beam, power control or activation/deactivation indication. The network node can perform, according to the message, at least one of: an adjustment of a beam pair configured by the wireless communication node, an adjustment, specific to or not specific to a beam, an amplifying gain, transmission power of power offset of the network node, or activation or deactivation of at least one link of the forwarding link.

In some implementations, the network node can perform, according to the status of the interference, at least one of: adjust a beam pair configured by the wireless communication node, adjust, specific to or not specific to a beam, an amplifying gain, transmission power of power offset of the network node, or activate or deactivate at least one link of the forwarding link.

At least one aspect is directed to a system, method, apparatus, or a computer-readable medium. A wireless communication node can receive an indication of a status of interference from a network node. The status of the interference may be experienced at the network node.

The systems and methods presented herein include a novel approach for measuring interference for network nodes. The systems and methods of the technical solution discussed herein can include the network node (e.g., SN or network-controlled repeater (NCR) mobile terminal (MT)). The network node (e.g., SN CU) can measure an interference (e.g., determine an interference value). The network node can report the interference status to the wireless communication node (e.g., BS, Gnb, or TRP).

In some implementation, the network node of the technical solution can perform an interference measurement according to at least one of the following example configurations or solutions:
Example configuration 1: compute/calculate the interference value by turning the output forwarding link on or off (e.g., enabling or disabling the output forwarding link);
Example configuration 2: calculate the interference value by configuring different power levels for SN FU;
Example configuration 3: calculate the interference value by sliding/moving/changing/configuring/adjusting the time domain measurement window;
Example configuration 4: calculate the interference value by shifting/changing the frequency domain resource for input signal and output signal;
Example configuration 5: calculate the interference value by configuring different polarization for input signal and output signal; and/or
Example configuration 6: calculate the interference value with specific beam pair for input signal and output signal.

In some implementations, the network node (e.g., SN CU) can be provided with various parameters for interference measurement from the wireless network node (e.g., BS). In some implementations, the network node may utilize a measurement method comprising at least one of received signal strength indicator (RSSI) measurement and/or reference signal receiving power (RSRP)/reference signal received quality (RSRQ) measurement.

In some implementations, the forwarding signal for measurement can comprise at least one of existing reference signal (RS), new RS, and/or dedicated sequence. In some implementations, triggered events may be defined (e.g., by the BS) to determine when to perform the measurement. In some implementations, a threshold may be defined to compare with the calculated interference value.

In some implementations, the network node (e.g., SN CU) may transmit/send/provide a report to the wireless communication node to inform/indicate/give the interference status. In some implementations, the network node may receive an indication from the wireless communication node to react (e.g., perform at least one action) according to the interference status. In some cases, the network node may autonomously or automatically perform one or more actions according to interference measurement results.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a schematic diagram of an example network, in accordance with some embodiments of the present disclosure;

FIG. 4 illustrates a schematic diagram of transmission links between BS to SN and SN to UE, in accordance with some embodiments of the present disclosure;

FIG. 5 illustrates an example block diagram for downlink (DL) forwarding by the SN, in accordance with some embodiments of the present disclosure;

FIG. 6 illustrates an example block diagram of interference on the SN, in accordance with some embodiments of the present disclosure;

FIG. 7 illustrates a structure of example implementations for addressing/resolving the interference of the SN, in accordance with some embodiments of the present disclosure;

FIG. 8 illustrates an example block diagram for a first measurement occasion for DL forwarding, in accordance with some embodiments of the present disclosure;

FIG. 9 illustrates an example block diagram for a second measurement occasion for DL forwarding, in accordance with some embodiments of the present disclosure;

FIG. 10 illustrates an example block diagram for a first measurement occasion for uplink (UL) forwarding, in accordance with some embodiments of the present disclosure;

FIG. 11 illustrates an example block diagram for a second measurement occasion for UL forwarding, in accordance with some embodiments of the present disclosure;

FIG. 12 illustrates an example block diagram of a measured signal including an interference, in accordance with some embodiments of the present disclosure;

FIG. 13 illustrates an example block diagram of a DL frequency shift forwarding, in accordance with some embodiments of the present disclosure; and

FIG. 14 illustrates a flow diagram of an example method for interference measurement for network nodes, in accordance with an embodiment of the present disclosure.

### DETAILED DESCRIPTION

### 1. Mobile Communication Technology and Environment

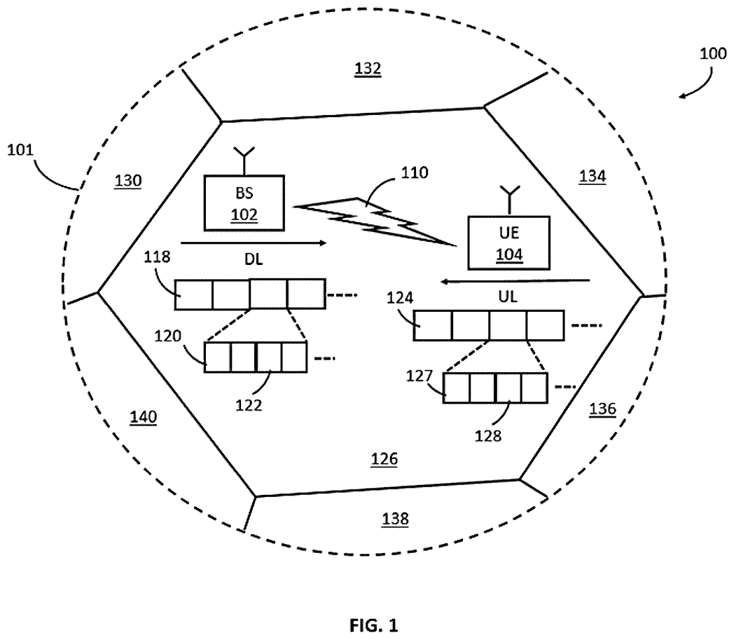

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

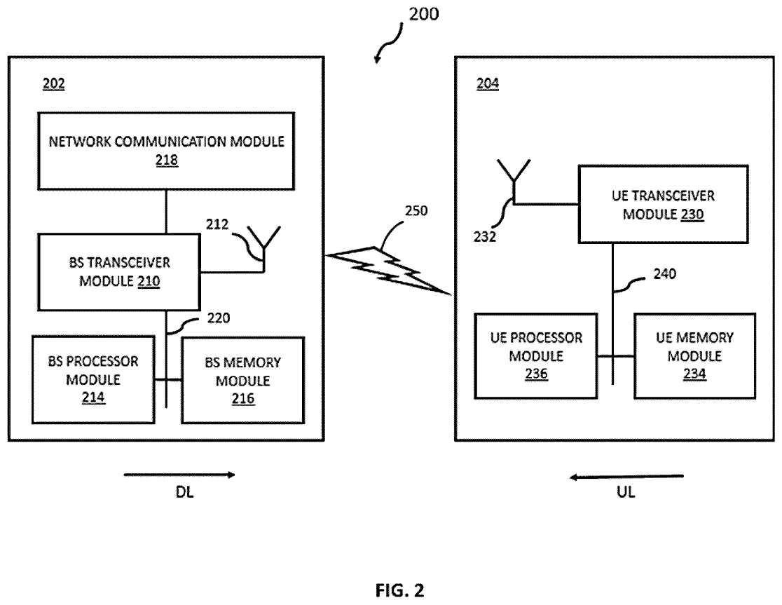

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (Enb), a serving Enb, a target Enb, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communicate with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Interference Measurement for Network Nodes (e.g., SN)

In certain systems (e.g., 5G new radio (NR), Next Generation (NG) systems, 3GPP systems, and/or other systems), a network-controlled repeater (NCR) can be introduced as an enhancement over conventional RF repeaters with the capability to receive and/or process side control information from the network. Side control information can allow a network-controlled repeater to perform/execute/operate its amplify-and-forward operation in a more efficient manner. Certain benefits can include at least mitigation of unnecessary noise amplification, transmissions and receptions with better spatial directivity, and/or simplified network integration.

The NCR can be regarded as a stepping stone of a re-configurable intelligent surface (RIS). A RIS node can adjust the phase and amplitude of the received signal to improve/enhance the coverage (e.g., network communication coverage). As discussed herein, network nodes, including and not limited to NCR, smart repeater, enhanced RF repeaters, RIS, and/or integrated access and backhaul (IAB), can be denoted, referred to, or provided as a smart node (SN) (e.g., network node) for simplicity. For example, the SN can include, correspond to, or refer to a kind of network node to assist the BS 102 to improve coverage (e.g., avoiding/averting blockage/obstructions, increasing transmission range, etc.).

In certain cases, an SN may maintain multiple links simultaneously, such as a link between the BS 102 and the SN and another link between the SN and the UE 104 to ensure signal forwarding for the BS 102 and the UE 104. However, the forwarded signal from the SN to the UE 104 may interfere with the reception of signal from the BS 102 to the SN, or vice versa (sometimes referred to or denoted as self-interference, self-oscillator, or self-excitation). Hence, the systems and methods of the technical solution discussed herein can provide or introduce functionalities for measuring the interference (e.g., self-interference) of/on the SN and/or potential actions to be performed by the BS 102 and/or the SN according to the interference measurement result, such as to address, resolve, or minimize interference of signal forwarding.

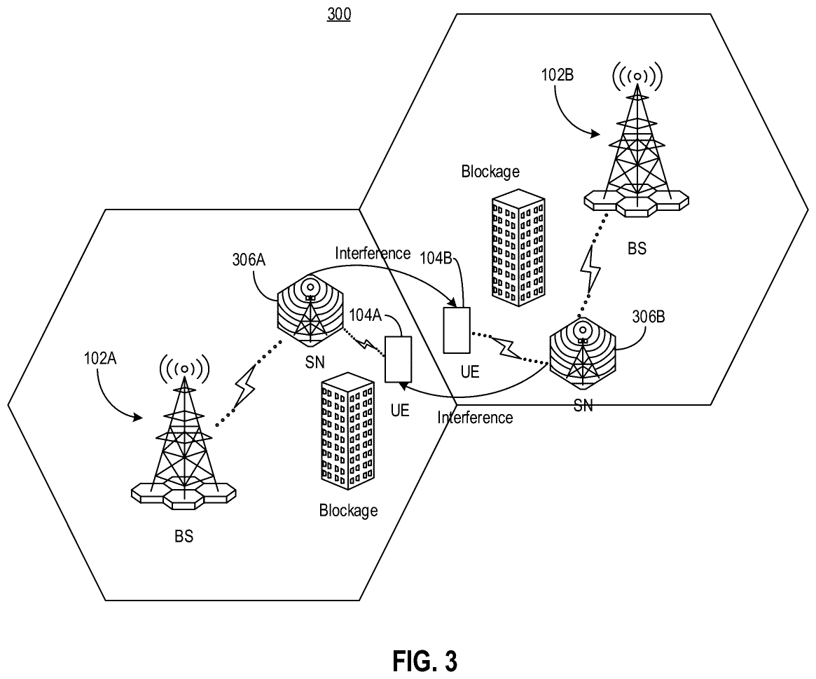

FIG. 3 illustrates a schematic diagram of an example network 300. As illustrated in FIG. 3, one or more BSs 102A-B (e.g., BSs 102) can serve one or more Ues 104A-B (e.g., Ues 104) respectively in their cells via the respective one or more SNs 306A-B (e.g., sometimes labeled as SN(s) 306), such as when there are blockages between the BS(s) 102 and the UE(s) 104.

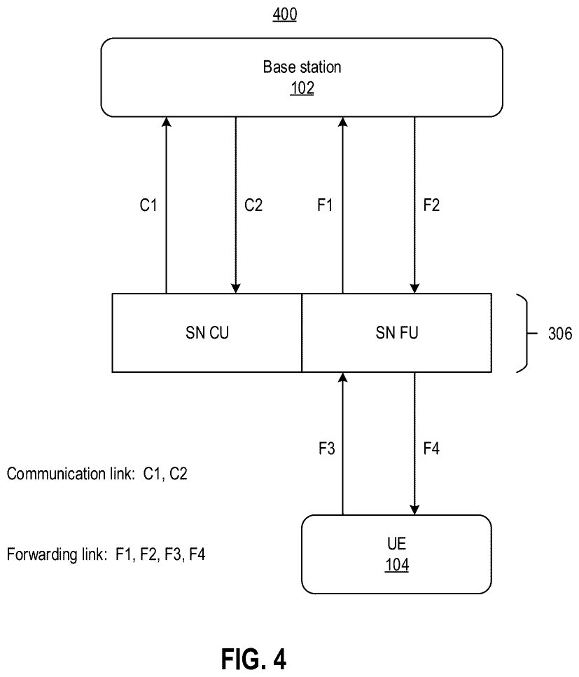

FIG. 4 illustrates a schematic diagram 400 of transmission links between BS 102 to SN 306 and SN 306 to UE 104. The SN 306 can include or consist of at least two units or functional parts/components (e.g., sometimes referred to as function entities), such as the communication unit (CU) (e.g., SN CU) and the forwarding unit (FU) (e.g., SN FU). The units of the SN 306 can support different functions for communication with at least one of the BS 102 and/or the UE 104. A first unit (or function entity) of the SN 306 may refer to the SN CU and a second unit (or function entity) of the SN 306 may refer to the SN FU or vice versa, in some cases. For example, the SN CU (e.g., first unit) can be a network-controlled repeater (NCR) MT. In another example, the SN FU (e.g., second unit) can be an NCR forwarder/forwarding (Fwd). The SN CU can act/behave or include features similar to a UE 104, for instance, to receive and decode side control information from the BS 102. The SN CU may be a control unit, controller, mobile terminal (MT), part of a UE, a third-party IoT device, and so on. The SN FU can carry out the intelligent amplify-and-forward operation using the side control information received by the SN CU. The SN FU may be a radio unit (RU), a RIS, and so on.

The transmission links between the BS 102 to SN 306 and the SN 306 to UE 104 as shown in FIG. 4 can be defined/described/provided as follows:
C1: Control link (C-link) from SN CU to BS;
C2: Control link (C-link) from BS to SN CU;
F1: Backhaul link from SN FU to BS;
F2: Backhaul link from BS to SN FU;
F3: Access link from UE to SN FU; and
F4: Access link from SN FU to UE.

Control link (e.g., sometimes referred to as a communication link) can refer to or mean that the signal from one side will be detected and decoded by the other side, so that the information transmitting in/via the control link can be utilized to control the status of forwarding links (e.g., backhaul links and/or access links, F-link). Forwarding link can mean that the signal from BS 102 or UE 104 is unknown to SN FU. In this case, the SN FU can amplify and forward signals without decoding them. For example, the F1 and F3 links can correspond to or be associated with the complete uplink (UL) forwarding link (e.g., backhaul link and access link, respectively) from UE 104 to BS 102, in which F1 is the SN FU UL forwarding link. Additionally, the F2 and F4 links can correspond to or be associated with the complete DL forwarding link (e.g., backhaul link and access link, respectively) from BS 102 to UE 104, in which F4 is the SN FU DL forwarding link. The F1 and F2 links can correspond to or be referred to as backhaul links and F3 and F4 links can correspond to or be referred to as access links.

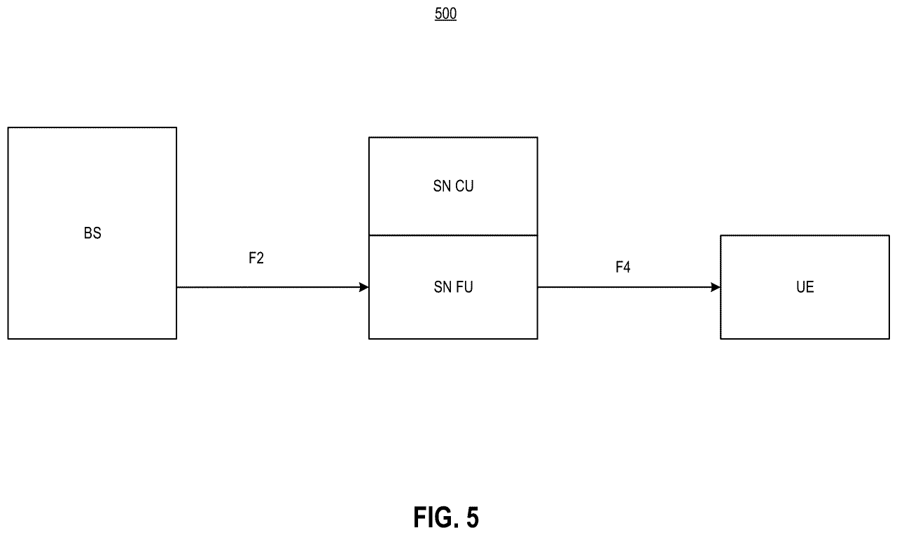

Referring to FIG. 5, depicted is an example block diagram 500 for DL forwarding by the SN 306 (e.g., SN FU). The DL forwarding can involve the F2 and F4 links, such as transmissions/signalings/communications from the BS 102 to the SN FU via the F2 link and from the SN FU to the UE 104 via the F4 link.

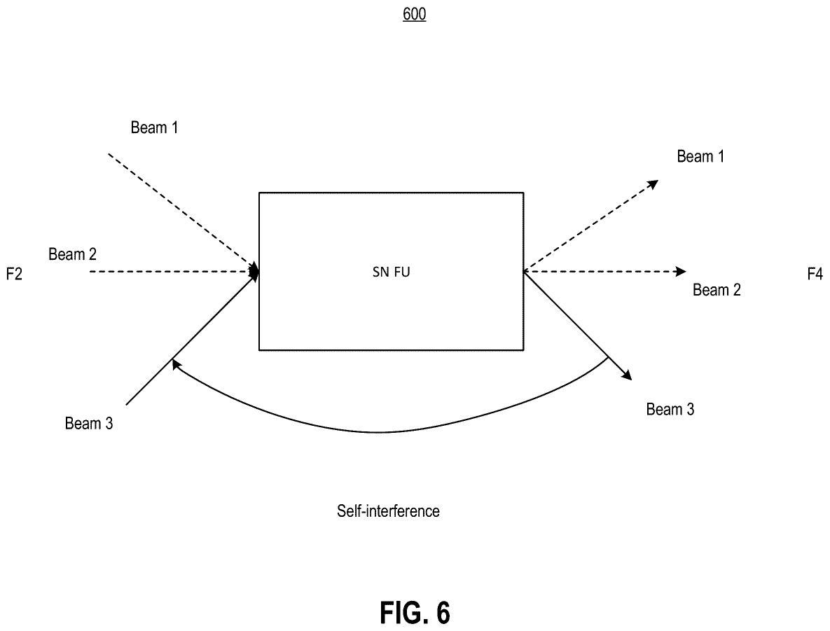

Referring to FIG. 6, depicted is an example block diagram 600 of interference on the SN 306. Taking the DL forwarding (e.g., of FIG. 5) by the SN 306 as an example, if the DL transmission (Tx) beam and DL reception (Rx) beam are within a certain angle, interference may occur between the Tx beam and the Rx beam. As shown in FIG. 6, the incoming beam 3 received via the F2 link may be within a certain angle as the outgoing beam 3 transmitted via the F4 link, potentially causing interference between the input and output ports of the SN 306 (e.g., SN FU). Similarly, interference may occur between the Tx beam and Rx beam for forwarding from the UE 104 to the BS 102, such as via F1 and F3 links. In various configurations discussed herein, the SN 306 can perform features, functionalities, and/or operations discussed herein to mitigate, avoid, minimize, or resolve the interference between the input and output signals (e.g., forwarding signals).

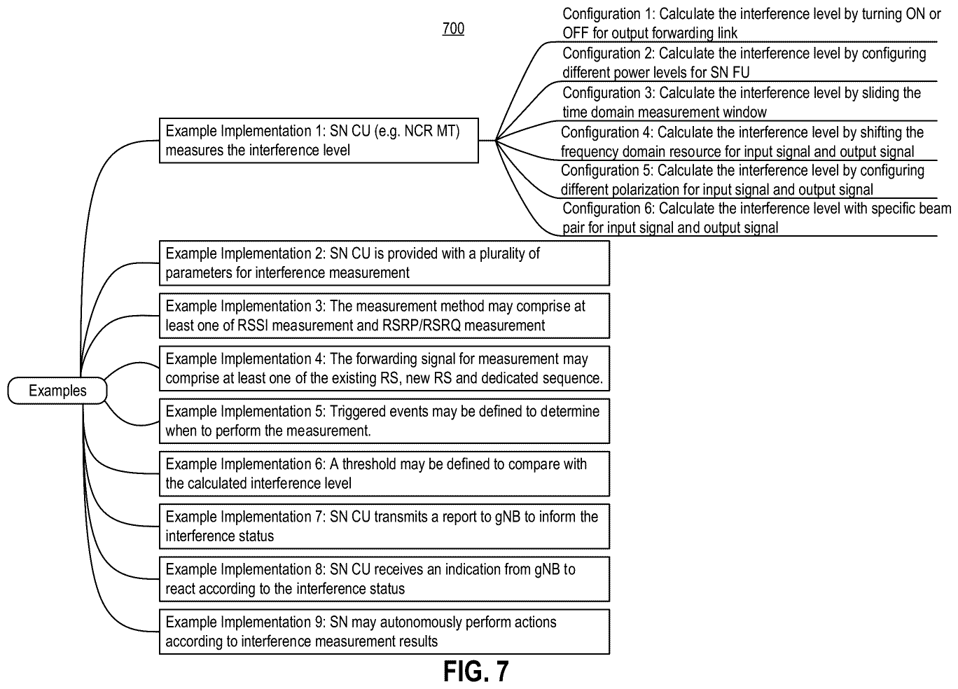

Referring to FIG. 7, depicted is a structure 700 of example implementations for addressing/resolving the interference of the SN. The structure 700 can include various example implementations described in further detail herein. The example implementations can be performed, executed, or operated by one or more devices within the network 300, such as the BS 102, the UE 104, and/or the SN 306.

### Example Implementation 1: SN Measures Interference

In various implementations, the SN 306 (e.g., SN CU, network node, or NCR MT) can measure, determine, or compute the interference (e.g., interference value, level, or magnitude) using at least one of various example configurations, including but are not limited to at least one of example configurations 1-6.

### Example Configuration 1: Calculate Interference Value by Turning Output Forwarding Link On or Off

In some configurations, the SN 306 can compute/calculate/determine the interference value by turning enabling/turning on or disabling/turning off the output forwarding link. The output forwarding link can be different depending on whether the forwarding is a DL forwarding or UL forwarding.

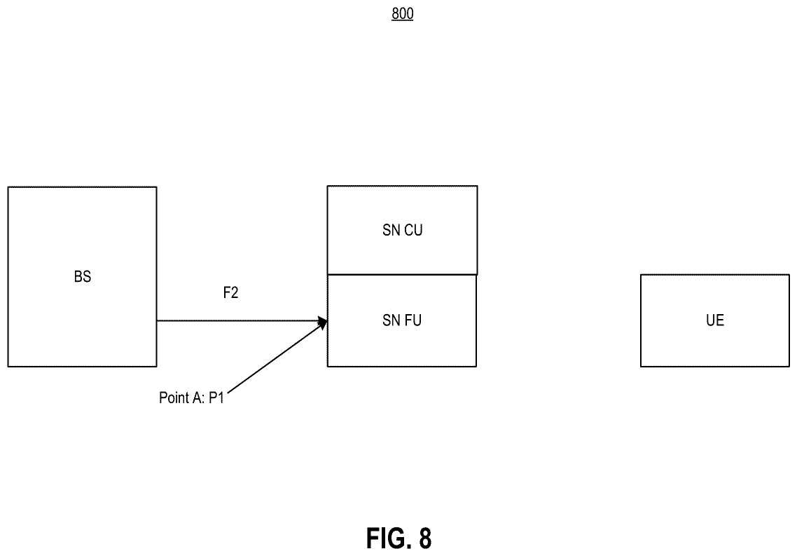

FIG. 8 depicts an example block diagram 800 for a first measurement occasion for DL forwarding. In the first measurement occasion for the DL forwarding, the F2 link can be in the “ON” state (e.g., enabled state) and the F4 link can be in the “OFF” state (e.g., disabled state). To be in the “ON state”, the SN 306 can turn on the F2 link or maintain the “ON” state of the F2 link to perform the measurement. To be in the “OFF” state, the SN 306 can turn off the F4 link or maintain the “OFF” state of the F4 link to perform the measurement. For the DL forwarding, the F2 link can be associated with the input of the SN FU. The F4 link can be associated with the output of the SN FU.

In this measurement occasion, the SN CU can measure/determine/compute the energy value at point A, e.g., at the input of the SN 306 or SN FU. In some cases, point A can be at the input of the SN CU, e.g., when SN CU and SN FU share the same RF component. The energy value at point A measured when the F2 link or C2 link (e.g., first link to the input) is on/activated and the F4 link (e.g., second link from the output) is off/deactivated can be denoted as P1 (e.g., first energy value). In this case, the SN 306 can determine the energy value without potential interference from the F4 link in the “OFF” state.

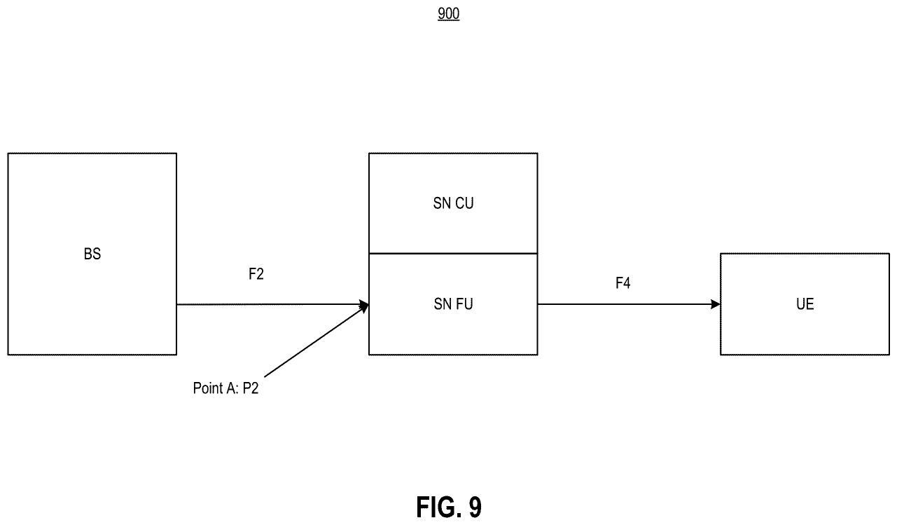

FIG. 9 depicts an example block diagram 900 for a second measurement occasion for DL forwarding. In the second measurement occasion for the DL forwarding, the F2 link (or C2 link) and the F4 link can both be in the “ON” state. In this case, the SN CU can measure the energy value at point A (e.g., denoted as P2 or second energy value) while both the F2 and F4 links are on. According to the measured energy values from the first and second measurement occasions, the SN 306 can compute/calculate the interference based on or as a function of at least one of the following values: α, P1, or P2. The value α can be greater than 0 (e.g., α>0, corresponding to a positive value). In some cases, the value α can be 1. In some cases, the value α can be 0.8. The value α can be configured/provided by the BS 102 based on other potential factors affecting the interference measurement, such as band, polarization, power, beam, etc.

For example, the interference value can be computed using the formula: (P2−P1)/P1. In some cases, the interference value can be determined based on a ratio between P1 and P2. In another example, the SN 306 can account for other factors affecting the interference. In this example, the interference value can be computed using the formula α*(P2−P1)/P1. The formula can be representative of the interference value.

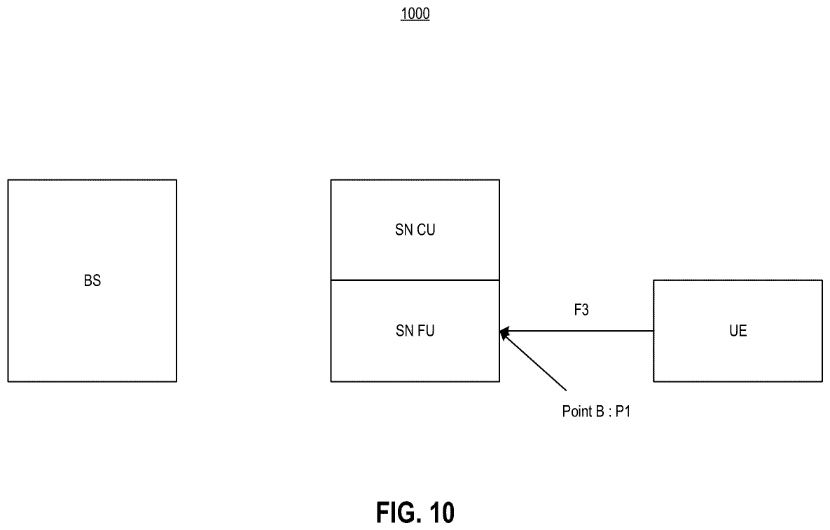

FIG. 10 depicts an example block diagram 1000 for a first measurement occasion for UL forwarding. In the first measurement occasion for the UL forwarding, the F3 link can be in “ON” state and the F1 link can be in “OFF” state. The SN CU can measure the energy value at point B, e.g., input port of the SN FU for UL forwarding. The measured energy value at point B when the F3 link is on and the F1 link is off can be denoted as P1 in this example.

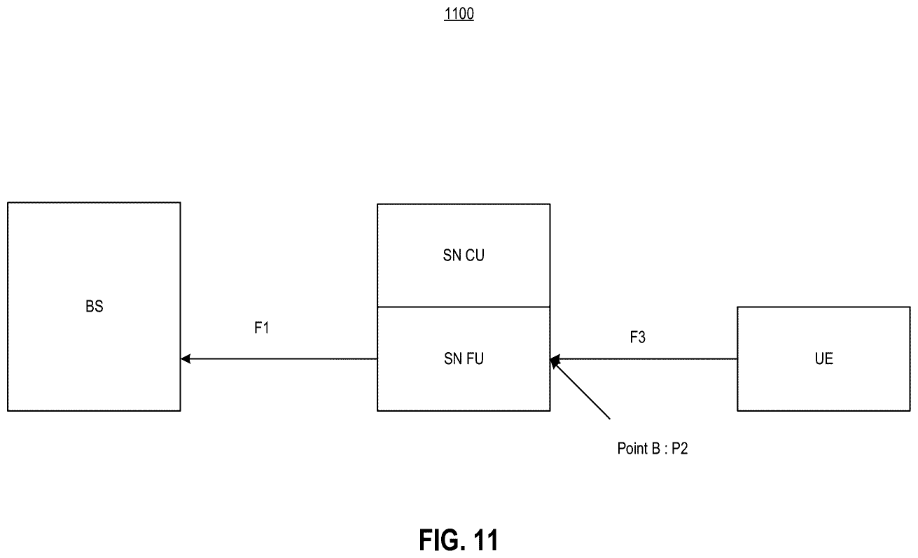

FIG. 11 depicts an example block diagram 1100 for a second measurement occasion for UL forwarding. In the second measurement occasion for the UL forwarding, the F3 link and the F1 link can both be in “ON” state. In this case, the SN CU can measure the energy value (e.g., denoted as P2) at point B when both the F1 and F3 links are on.

Subsequently, the SN 306 can compute/calculate the interference based on at least one of the following values: α, P1, P2. The value α can be greater than 0. In some cases, the value α can be 1. In some cases, the value α can be 0.8. The value α can be configured by the BS 102 based on other factors affecting the interference, such as band, polarization, power, beam, etc. For example, the SN 306 can compute the interference value based on (P2−P1)/P1. In another example, to account for one or more factors affecting the interference, the SN 306 can compute the interference value based on α*(P2−P1)/P1. According to at least one of the above formulas, the SN 306 can identify the difference between power/energy level/value (e.g., P2−P1) and scale against P1 (e.g., determined when the output port is disabled), thereby determining how the energy level at the input port is affected by the output signal.

Example configurations/settings/parameters to perform the example configuration 1 can include at least one of the following.
Time domain resource for each measurement occasion.
Reference signal type.
Measurement method (e.g., example configuration) type.
Frequency domain resource.
ON-OFF indication (e.g., indicates whether to activate or deactivate certain links) for each measurement occasion.
   The ON-OFF indication may be explicitly or implicitly indicated. For implicit indication, the ON-OFF indication may be implicitly determined by beam indication. For example, the time domain resource associated with the valid beam index can be regarded as ON/active state for a certain link (e.g., at least one of F1-F4). In another example, the time domain resource associated with the specific beam index (e.g., beam index 0) can be regarded as an ON/active state for a certain link.
Cell information.

### Example Configuration 2: Calculate Interference Value by Configuring Different Power Values

In some configurations, the SN 306 can configure/change/update/adjust the power values/levels/magnitudes of SN FU to compute the interference value. In this configuration, the power value may refer to or correspond to at least one of the amplifying gain, transmission power, and/or power offset for SN FU. The measurement point A or point B may be similar to those described in at least one of FIGS. 8-11 for the UL and/or DL forwarding.

In this configuration, the SN 306 (e.g., SN CU) or BS 102 may perform the interference measurement in multiple measurement occasions, such as denoted as N (e.g., N can represent an integer of at least 2 (N>=2)) measurement occasions. During (or while in) the N measurement occasions, the UL (e.g., F1 and/or F3) and/or DL (e.g., F2 and/or F4) forwarding link can be activated or in an “ON” state. The SN 306 can measure the respective energy/power value for each of the N measurement occasions when the forwarding links are activated. Each of the N measurement occasions can include or be configured with different power values for SN FU (e.g., NCR Fwd). The power values associated with the respective N measurement occasions can be denoted as L₁, L₂, . . . , L_{N}, for example.

In some implementations, the N measurement occasions can be contiguous in the time domain. In some implementations, the duration of measurement occasion can be configured by the BS 102 (or the network). In some implementations, the duration of measurement occasion can be the same as the duration of the reference signal for measurement. In some other implementations, the duration of measurement occasion may be predefined/predetermined/pre-configured in the specification. For example, the measurement occasion may occupy at least one of 1 symbol, 2 symbols, 1 slot, 5 us, 1 ms, etc.

In some implementations, each measurement occasion may occupy the same duration in/of the time domain resource. In some implementations, the configured power difference between adjacent measurement occasions may be the same, e.g., L_{N}-L_{N-1}=L_{N-1}-L_{N-2}= . . . =L₂-L₁. For example, in the first measurement occasion, the configured power/energy value can be L₁ and SN CU can measure the energy value at the measurement point, denoted as P₁. In the second measurement occasion, the configured power value can be L₂ and SN CU can measure the energy value at the measurement point, denoted as P₂. Further, in the N^{th} measurement occasion, the configured power value can be L_{N} and SN CU can measure the energy value at the measurement point, denoted as PN, for example.

The interference can be calculated based on or as a function of at least one of the following values: α, L₁, L₂, . . . , L_{N}, P₁, P₂, . . . , P_{N}, where α can be greater than 0 (e.g., a can be 1, 0.8). The value α can be configured by the BS 102 based on other affecting factors, such as, band, polarization, power, beam, etc.

In some cases, the interference may be calculated per configured power value based on or as a function of at least one of the following values: α, L₁, L₂, . . . , L_{N}, P₁, P₂, . . . , P_{N}. For example, for at least one of L₁, L₂, . . . , L_{N}, at least one of the associated interference values can be calculated.

In some cases, the interference (e.g., referring to or with regards to at least one of example configurations 1 and/or 3-6) may be calculated per configured power. For each configured power, a value of interference can be calculated based on the measurement results and calculation function, such as described in at least one of example configurations 1 and/or 3-6, where the configured power may include at least one of transmission power, amplifying gain, and/or power offset.

For example, the SN 306 can compute the value average {(P_{N}-P_{N-1})/(L_{N}-L_{N-1}), (P_{N-1}-P_{N-2})/(L_{N-1}-L_{N-2}), . . . , (P₂−P₁)/(L₂-L₁)} as the interference value. In another example, the SN 306 can compute the value α*average {(P_{N}-P_{N-1})/(L_{N}-L_{N-1}), (P_{N-1}-P_{N-2})/(L_{N-1}-L_{N-2}), . . . , (P₂−P₁)/(L₂-L₁)} as the interference value.

In some cases, N may be equal to 2. For example, when N=2, the SN 306 can compute the interference value based on (P₂−P₁)/(L₂−L₁). In another example, when N=2, the SN 306 can compute the interference value based on α*(P₂−P₁)/(L₂−L₁).

Example parameters for example configuration 2 can include at least one of the following.
Time domain resource for each measurement occasion.
Frequency domain resource.
Power indication (e.g., transmission power, power offset, and/or amplifying gain) for each measurement occasion.
Reference signal type.
Measurement method type.
Cell information.

### Example Configuration 3: Calculate Interference Value by Sliding Time Domain Measurement Window

In some configurations, the SN 306 may compute the interference value by sliding/shifting/moving/changing the time domain measurement window. For example, when an input signal is provided for forwarding, there may be a delay in forwarding an output signal. The delay can be between the input signal and the output signal. For example, the delay may be caused by the internal delay of the hardware structure. In another example, the delay may be due to cache or storage. The measurement point discussed herein may be similar to or the same as the measurement points discussed in example configuration 1 for UL and/or DL forwarding.

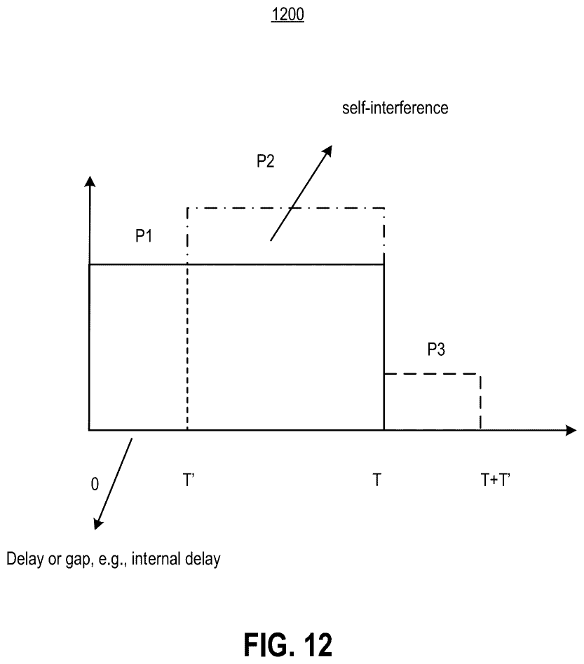

Referring to FIG. 12, depicted is an example block diagram 1200 of a measured signal including an interference. As shown in block diagram 1200, for example, the signal length/duration can be represented as T2, the measurement delay or gap can be represented as T1, and the start time of the measurement can be represented as TO. T1 can be caused by the internal delay of SN FU (e.g., NCR Fwd). The SN 306 can measure a respective energy value at an input of the SN FU for at least one of the following time domain windows, while the first link to the input and a second link from the output of the SN FU is activated or in “ON” state, such as for DL and/or UL forwarding:
[T0, T0+T1]: this window (e.g., first time domain window) can be defined from a first time instance (e.g., TO) to a second time instance, where the second time instance can be or correspond to T1 added to the first time instance (e.g., indicative of the duration of the window). In this window, the SN 306 can measure the respective energy at the measurement point, an input signal can be present without interference, where the measured energy value can be denoted as P1;
[T0+T1, T0+T2]: this window (e.g., second time domain window) can be defined from the second time instance to a third time instance, where the third time instance can be or correspond to T2 added to the first time instance (e.g., T0). In this window, at the measurement point, the measured signal can include the input signal and the interference of the output signal, where the interference may be presented after the delay of the first time domain window. The measured energy value for the second window can be denoted as P2; and/or
[T0+T2, T0+T2+T1]: this window (e.g., third time domain window) can be defined from the third time instance to a fourth time instance, where the fourth time instance can be T1 added to the third time instance. As discussed herein above, T1 can correspond to an internal delay of the SN FU and T2 can correspond to a signal length. In this window, at the measurement point, the SN 306 may measure the interference signal, where the measured energy value can be denoted as P3.

In some cases, if T1>=T2, the second measurement window may not be present. The interference can be calculated/computed based on or according to at least one of the following values: α, P1, P2, P3, where α (e.g., α>0, such that a can be 1) can be configured by the BS 102 based on other affecting factors, such as band, polarization, power, beam, etc.

The value of T0, T1, and/or T2 can be determined by or according to at least one of: the capabilities of the network node, the duration of the measurement, the time domain resource of the reference signal, a predefined value, a parameter configured by the BS 102 (e.g., wireless communication node), the start time of the measurement, a predefined time instance, and/or a time instance triggered by the wireless communication device, among others.

For example, the SN 306 can compute or determine the interference value based on the formula (P2−P1)/P1 (e.g., the formula representing the interference value). In another example, the SN 306 can compute the interference value based on the formula P3/P1. In yet another example, the SN 306 can compute the interference value based on the formula (P3+P2−P1)/(2*P1). In further example, the SN 306 can compute the interference value based on the formula α*(P2−P1)/P1, α*P3/P1, and/or α*(P3+P2−P1)/(2*P1).

Examples of the parameters for example configuration 3 can include at least one of the following:
Time domain resource for each measurement occasion, including at least one of measurement duration T2, measurement delay or gap T1, and starting time of the first time domain window T0.
Frequency domain resource.
Reference signal type.
Measurement method type.
Cell information.

### Example Configuration 4: Calculate Interference Value by Shifting Frequency Domain Resource

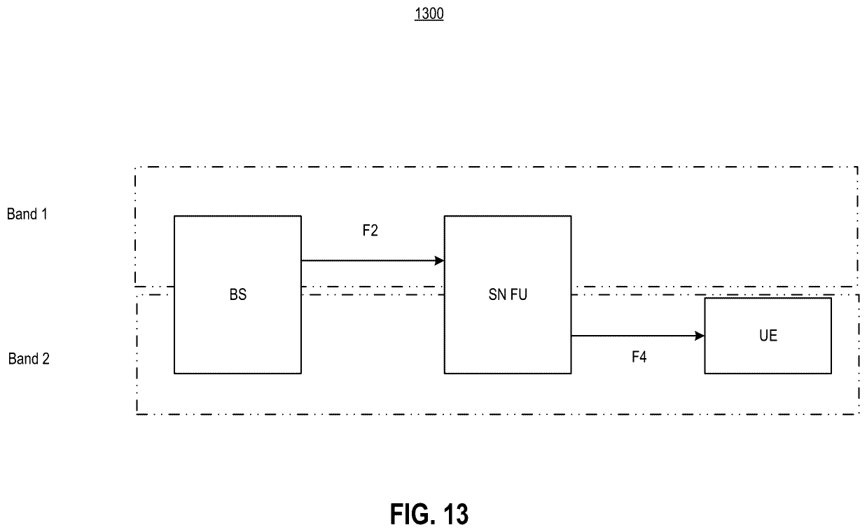

In some configurations, the SN 306 may compute the interference value by shifting the frequency domain resource for the input signal and/or the output signal. Referring to FIG. 13, depicted is an example block diagram 1300 of a DL frequency shift forwarding. As shown, the input signal and the output signal may be in a different frequency domain resource. In this example, the input signal can be in band 1 (e.g., the first frequency domain resource) and the output signal can be in band 2 (e.g., the second frequency domain resource). These bands associated with the input and output signals may not be overlapped. The measurement point can be the same as discussed in example configuration 1 for UL and/or DL forwarding.

In FIG. 13, in DL forwarding, the frequency shift forwarding can be shown. In the measurement occasion, the SN 306 (e.g., SN CU) can measure the energy value of an input signal of the input (e.g., at the measurement point) in band 1. The measurement point can correspond to or be at the input of SN FU in the first frequency band of the input signal when the first link to the input and the second link from the output of the SN FU is activated (e.g., F2 and F4 links are active). The measured energy value at band 1 can be denoted as P1 (e.g., first energy value).

In the measurement occasion, the SN CU can measure a second energy value (e.g., denoted as P2) of the input signal at the input of the SN FU in a second frequency band of an output signal corresponding to the input signal (e.g., at the measurement point in band 2 for forwarding the received input signal as the output signal). The SN CU can perform the measurement when the first link to the input and the second link from the output of the SN FU is activated.

The SN 306 (e.g., SN CU) can compute the interference based on at least one of the following values: α, P1, P2, where α (e.g., α>0, such that α can be 1) can be configured by the BS 102 based on other affecting factors, such as band, polarization, power, beam, etc. For example, the SN 306 can compute the interference value as P2/P1. In another example, the SN 306 can compute the interference value as α*P2/P1.

Examples of parameters for example configuration 4 can include at least one of the following:
Time domain resource for the measurement occasion; and/or
Frequency domain resource for different bands (e.g., band 1 for input signal and/or band 2 for output signal), for each band, the frequency resource can include at least one of: a carrier index, a band index, a BWP index, a frequency range index, a start RB index, an RB number, an RE number, a frequency offset, etc.
Reference signal type.
Measurement method type.
Cell information.

### Solution 5: Calculate Interference Value by Configuring Different Polarization

In some configurations, the SN 306 can compute the interference value by configuring different polarization for the input signal and/or the output signal. For example, the input signal and output signal can be configured with different polarization, such as the input signal with a first polarization and the output signal with a second polarization. The different polarizations can be orthogonal. The measurement point discussed herein can be described in conjunction with example configuration 1. The SN CU can perform the measurements of the energy values discussed herein when the first link to the input and the second link to the output of the SN FU is activated.

In the measurement occasion, SN CU can measure a first energy value/level (e.g., denoted as P1) of the input signal at the measurement point (e.g., the input of SN FU) at/with a first polarization of the input signal. Since the output signal is using a second polarization, different from the first polarization, the output signal may not cause interference to the input of the SN FU at the measurement point with the first polarization. In this case, P1 can be assumed to include the input signal without interference from the output signal, although background noise, among other types of interferences within the network environment, may be present (e.g., from other cells).

In the measurement occasion, SN CU can measure a second energy value (e.g., denoted as P2) of the input signal at the input of the SN FU (e.g., at the measurement point) with the second polarization. Since the output signal is using the second polarization, the output signal may cause interference at the measurement point with the second polarization, although the input signal may not have any leaked energy at the measurement point with the second polarization. Hence, in this case, P2 may be assumed to include the interference signal, among other background noise and/or interferences (e.g., from other cells).

The SN 306 can compute the interference based on or as a function of at least one of the following values: α, P1, P2, where α (e.g., α>0, such that α can be 1) can be configured by the BS 102 based on other affecting factors, such as band, polarization, power, beam, etc. For example, the SN 306 can compute the interference value as P2/P1. In another example, the SN 306 can compute the interference value as α*P2/P1.

Example of parameters for example configuration 5 can include at least one of the following:
Time domain resource for the measurement occasion;
Frequency domain resource; and/or
Polarization indication for the input signal and/or the output signal.
Reference signal type.
Measurement method type.
Cell information.

### Example Configuration 6: Calculate Interference Value with Specific Beam Pair

In some configurations, the SN 306 or BS 102 can compute the interference value with specific beam pairs for the input signal and the output signal of SN 306. The example configuration 6 can be performed additionally with at least one of example configurations 1-5, such that the interference value may be calculated with beam pair information (e.g., interference per beam pair). For example, if the Rx reception beam at the input of the SN FU (e.g., at the measurement point) is y, and the Tx transmission beam at the output of the SN FU is x, the SN 306 can compute the interference for the specific beam pair (x,y) (e.g., denoted as E(x,y)).

### Joint Example Configuration 1 and Example Configuration 6

In this example, the SN 306 can perform the measurement with a specific beam pair (x,y), with other procedures performed similarly to example configuration 1. In this case, the SN 306 can compute the interference as E (x,y)=(P2−P1)/P1. For instance, using the specific beam pair (x,y), the interference value can be represented as or correspond to (P2−P1)/P1. The interference value for other beam pairs may be calculated using similar features or functionalities discussed herein.

In another example, the SN 306 can perform the measurement with a specific beam pair (x,y), with other procedures performed similarly to example configuration 1. In this case, the SN 306 can compute the interference as E (x,y)=α*(P2−P1)/P1. For instance, using the specific beam pair (x,y), the interference value can correspond to α*(P2−P1)/P1, where α can be a positive value configured by the BS 102 based on other affecting factors, such as band, polarization, power, beam, etc. Other interference values for other beam pairs can be calculated in a similar manner.

### Joint Example Configuration 2 and Example Configuration 6

In some implementations, the SN 306 can perform the measurement with a specific beam pair (x,y), with other procedures performed similarly to example configuration 2. In this case, the SN 306 can compute the interference as E (x,y)=(P2−P1)/(L₂−L₁). For instance, using the specific beam pair (x,y), the interference value can correspond to (P2−P1)/(L₂−L₁). The interference value for other beam pairs can be computed in a similar manner.

In some implementations, the SN 306 can perform the measurement with a specific beam pair (x,y), with other procedures performed similarly to example configuration 2. In this case, the SN 306 can compute the interference as E (x,y)=α*(P2−P1)/(L₂−L₁). For instance, using the specific beam pair (x,y), the interference value can correspond to α*(P2−P1)/(L₂−L₁), wherein a can be a positive value configured by the BS 102 based on other affecting factors, such as band, polarization, power, beam, etc. The interference value for other beam pairs can be computed in a similar manner. In various arrangements, the SN 306 can perform the measurement for a specific beam pair in conjunction with other example configurations discussed herein.

Example of parameters for example configuration 6 can include at least one of the following:
Time domain resource for the measurement occasion;
Frequency domain resource; and/or
Beam indication for at least one of the reception beam and/or the transmission beam.
Reference signal type.
Measurement method type.
Cell information.

### Example Implementation 2: SN CU Provided with a Plurality of Parameters for Interference Measurement

In various implementations, the SN 306 (e.g., SN CU) can receive or be provided with various parameters from the BS 102 to perform the interference measurements. The provided parameters can be used in part, for instance, to perform at least one of the example configurations 1-6, among others discussed herein. The parameters can be transmitted to SN 306 via at least one of RRC, MAC CE, DCI, and/or system information, among other types of signalings. The measurement can be a periodic measurement or aperiodic measurement. For aperiodic measurement, a measurement event can be a triggering event, e.g., the event can be triggerd based on or according to the indication from the BS 102 or the UE 104. The parameters can include at least one of the following:
Time domain resource:
   The time domain resource can include at least one of: a start time, a pattern, a start and length indicator value (SLIV), a time offset, a slot offset, a symbol offset, a time domain resource allocation (TDRA) index, a duty cycle, a duration (in symbols or in slots), a periodicity, reference signal resource index, RSSI resource index, and/or a reference SCS, among others.
   In some implementations, the periodicity and slot offset may or may not be combined into a single parameter.
   In some implementations, the reference signal resource index may comprise at least one of SSB index, CSI-RS index, SRS index, preamble index, etc.
Frequency domain resource:
   The frequency domain resource can include at least one of: a carrier index, a band index, a BWP index, a frequency range index, a start RB index, an RB number, an RE number, a frequency offset, etc.
   The frequency domain resource may be the same as the indicated reference signal. In such cases, the frequency domain resource may not need to be explicitly indicated. For example, if the indicated reference signal is SSB, the measurement can be performed in the same frequency domain resource with SSB.
   The frequency domain resource for measurement may be the same as the frequency domain resource for SN CU.
   The frequency domain resource may be a default value. For example, the SN 306 can perform forwarding in a dedicated frequency domain resource, such that the frequency domain resource may not be configured or required.
Reference signal type.
   This parameter may indicate the reference signal type used for the measurement. The reference signals type may include at least one of SSB, CSI-RS, SRS, PRACH, etc.
Measurement method type.
   This parameter may indicate the measurement method type including at least one of RSSI measurement and/or reference signal-based measurement (e.g., RSRP, RSRQ, SINR).
Cell information.
   This parameter may indicate the cells in which the measurement is performed. The cell information may include at least one of the cell ID, serving cell ID, and/or cell group ID.
   The cell information may be implicitly indicated. For example, the configuration (e.g., cell information) may be indicated in a cell-specific indication, such that the measurement can be performed in the same cell of SN CU. In another example, the configuration may be indicated in a cell group level indication, such that the measurement can be performed in the same cell group of SN CU.
Power indication:
   The power indication can include at least one of transmission power, amplifying gain, a power factor (e.g., α, which can be a positive value configured by the BS 102 based on other affecting factors, such as band, polarization, power, and/or beam) and/or power offset, among others.
Beam indication:
   The beam indication can include at least one of the beam information (e.g., beam index, TCI state, etc.) of the Rx reception beam and/or the Tx transmission beam.
ON-OFF indication:
   The ON-OFF indication (e.g., activation or deactivation information) can be applied for at least one of the forwarding links F1, F2, F3, and/or F4, such as for the first link or the second link associated with at least one of the UL or DL forwarding.
   The link level ON-OFF indication may be explicitly or implicitly indicated. For implicit indication, the ON-OFF indication may be implicitly determined by beam indication. For example, the time domain resource associated with the valid beam index can be regarded as an ON state for a certain link (e.g., at least one of F1-F4). In another example, the time domain resource associated with the specific beam index (e.g., beam index 0) can be regarded as an ON state for a certain link.
Polarization indication:
   The polarization indication can include the polarization of at least one of the input signal and/or the output signal.
UL/DL indication:
   The UL/DL indication (e.g., measurement direction) can indicate whether the measurement is performed in UL forwarding or DL forwarding, such that the measurement point can be derived or determined as described or shown in conjunction with example configuration 1 of example implementation 1 (e.g., point A or point B). For instance, the UL/DL indication can include an indication of UL, DL, and/or both UL and DL.
Threshold:
   The threshold for a level of interference can be used to compare with the interference value or the measurement results (e.g., P1 and/or P2), such that an interference status can be determined. For example, the threshold can be used to determine whether there is an interference issue, and/or whether the corresponding beam pair is valid or invalid, etc.
   The threshold can be used to compare with the interference value or measurement results (e.g., P1 and/or P2) to determine whether to send a report to the BS 102 (e.g., Gnb). For example, if the interference value or measurement result is larger/greater than the threshold, SN CU can send the interference status report to the BS 102.
   The threshold can be used to compare with the interference value or measurement results (e.g., P1 and/or P2) to determine whether to perform a corresponding action. For example, if the interference value or measurement result is larger than the threshold, SN CU can automatically or responsively adjust the beam, power, and/or ON-OFF status of SN FU.
Indication for selection of the measurement configuration:

This indication can explicitly indicate, by the BS 102 to the SN 306, which of the measurement configuration to utilize, such as from at least one of the example configurations 1-6. In some cases, measurement configuration may be implicitly selected based on at least one of the parameters:
Example 1: if ON-OFF indication is indicated, the SN 306 can determine that example configuration 1 is implicitly selected.
Example 2: if power indication is indicated, the SN 306 can determine that example configuration 2 is implicitly selected.
Example 3: if more than one time domain measurement windows are indicated by time domain resource indication, the SN 306 can determine that example configuration 3 is implicitly selected.
Example 4: if more than one frequency domain measurement windows are indicated by frequency domain resource indication, the SN 306 can determine that example configuration 4 is implicitly selected.
Example 5: if polarization indication is indicated, the SN 306 can determine that example configuration 5 is implicitly selected.
Example 6: if beam indication is indicated, the SN 306 can determine that example configuration 6 is implicitly selected.
Example 7: if ON-OFF indication and beam indication are indicated, the SN 306 can determine that a joint configuration including example configurations 1 and 6 is implicitly selected.
Example 8: if power indication and beam indication are indicated, the SN 306 can determine that a joint configuration including example configurations 2 and 6 is implicitly selected.
Example 9: if more than one time domain measurement windows and beam indication are indicated, the SN 306 can determine that a joint configuration including example configurations 3 and 6 is implicitly selected.
Example 10: if more than one frequency domain measurement windows and beam indication are indicated, the SN 306 can determine that a joint configuration including example configurations 4 and 6 is implicitly selected.
Example 11: if polarization indication and beam indication are indicated, the SN 306 can determine that a joint configuration including example configurations 5 and 6 is implicitly selected.

In some implementations, the parameters can be transmitted to SN CU in RRC signaling via PDSCH. In RRC configuration, the measurement may be performed periodically. For example, the RRC configuration may include one or more list/set of measurement resources (e.g., a resource set). In each measurement resource list/set, the configuration of each measurement resource can include at least one of resource ID/index, reference SCS, start PRB, number of PRBs, start symbol in a slot (or symbol offset), duration, number of symbols, number of slots, periodicity, slot offset (periodicity and offset may be combined into single parameter), and/or reference cell index (e.g., serving cell index). In another example, at least one of the reference SCS, start PRB, number of PRBs, duration, number of symbols, number of slots, periodicity, and/or reference cell index (e.g., serving cell index) can be common for all the measurement resources in the measurement resource list/set. In yet another example, a priority index may be included in the RRC configuration to provide priority to (e.g., prioritize) one measurement resource list/set relative to other measurement configuration/indication, e.g., aperiodic measurement indication via DCI. In further example, the configuration index to indicate the selection of the measurement configuration can be included in each measurement resource list/set. In another example, at least one of reference signal type, and/or measurement method type may be included in the RRC signaling which may be common for the list of measurement resources.

In some implementations, the parameters can be transmitted/broadcast to SN CU in system information, e.g., SIB1. When the parameters are broadcasted via system information, the measurement resources may be common for all the SNs 306 in the cell. In system information, the measurement may be performed periodically. For example, the configuration may include one or more lists/sets of measurement resources (e.g., a resource set). In each measurement resource list/set, the configuration of each measurement resource can include at least one of resource ID/index, reference SCS, start PRB, number of PRBs, start symbol in a slot (or symbol offset), duration, number of symbols, number of slots, periodicity, slot offset (periodicity and offset may be combined into single parameter), and/or reference cell index (e.g., serving cell index). In another example, at least one of the reference SCS, start PRB, number of PRBs, duration, number of symbols, number of slots, periodicity, and/or reference cell index (e.g., serving cell index) can be common/shared for all the measurement resources in the measurement resource list/set.

In some implementations, the parameters can be transmitted to SN CU in DCI via PDCCH. In DCI indication, the measurement may be performed aperiodically. In one example, DCI can configure one or more of the measurement resources. Each measurement resource can include at least one of resource ID/index, reference SCS, start PRB, number of PRBs, start symbol in a slot (or symbol offset), duration, number of symbols, number of slots, periodicity, slot offset (periodicity and offset may be combined into single parameter), and/or reference cell index (e.g., serving cell index). In one example, the start time of the measurement can be determined by slot n when SN CU received the DCI-carrying measurement configuration and/or the scheduling offset k. In some cases, k can be included in DCI. For example, k can be a value determined by or according to the capability of the SN 306. In another example, k can be a pre-defined value, such as 0, among others. In yet another example, the start time of the measurement can be determined based on n+k+slot offset, where the slot offset can be configured in RRC or DCI, among other types of signalings.

In some implementations, the parameters can be transmitted to SN CU in DCI via PDCCH and/or in RRC via PDSCH. In some examples, in joint RRC and DCI indication, the measurement may be performed aperiodically. In one example, RRC can configure a list of measurement resources. In this example, DCI can select one or more of the measurement resources in the pre-configured list in RRC. In the measurement resource list/set in RRC, the configuration of each measurement resource can include at least one of resource ID/index, reference SCS, start PRB, number of PRBs, start symbol in a slot (or symbol offset), duration, number of symbols, number of slots, periodicity, slot offset (periodicity and offset may be combined into single parameter), and/or reference cell index (e.g., serving cell index). In another example, at least one of the reference SCS, start PRB, number of PRBs, duration, number of symbols, number of slots, periodicity, and/or reference cell index (e.g., serving cell index) can be common for all the measurement resources in the measurement resource list/set. In yet another example, DCI can include one or more of the measurement resource IDs to select one or more of the measurement resources from the RRC configured list. In further example, the start time of the measurement can be determined by slot n when SN CU received the DCI-carrying measurement configuration and the scheduling offset k. In some cases, k can be included in DCI. The k can be a value determined based on or by the capability of the SN 306. In some cases, k can be a pre-defined value, such as 0. In another example, the start time of the measurement can be determined based on n+k+slot offset, where the slot offset can be configured in RRC and/or DCI, etc.

In some implementations, the parameters can be transmitted to SN CU in MAC CE via PDSCH. In MAC CE indication, the measurement may be performed periodically or aperiodically. In one example, MAC CE can configure one or more measurement resources. Each measurement resource can include at least one of resource ID/index, reference SCS, start PRB, number of PRBs, start symbol in a slot (or symbol offset), duration, number of symbols, number of slots, periodicity, slot offset (periodicity and offset may be combined into single parameter), and/or reference cell index (e.g., serving cell index).

In some implementations, the parameters can be transmitted to SN CU in MAC CE via PDSCH and in RRC via PDSCH. In some cases, in joint RRC and MAC CE indications, the measurement may be performed periodically. For example, RRC can configure a list of measurement resources. In this case, MAC CE can select one or more of the measurement resources in the pre-configured list in RRC. In the measurement resource list/set in RRC, the configuration of each measurement resource can include at least one of resource ID/index, reference SCS, start PRB, number of PRBs, start symbol in a slot (or symbol offset), duration, number of symbols, number of slots, periodicity, slot offset (periodicity and offset may be combined into single parameter), and/or reference cell index (e.g., serving cell index). In another example, at least one of reference SCS, start PRB, number of PRBs, duration, number of symbols, number of slots, periodicity, and/or reference cell index (e.g., serving cell index) can be common for all the measurement resources in the measurement resource list/set. In further example, MAC CE can include one or more of the measurement resource IDs to select one or more of the measurement resources from the RRC configured list.

### Example Implementation 3: The Measurement Configuration of at Least One of RSSI Measurement, RS Based Measurement and/or SINR Measurement

In some implementations, the measurement method or configuration can include at least one of received signal strength indicator (RSSI) measurement, reference signal-based measurement (e.g., reference signal receiving power (RSRP)/reference signal received quality (RSRQ) measurement) and/or signal to interference plus noise ratio (SINR). According to whether SN CU is aware of the measured signals (e.g., measurement method), the following cases can be provided as examples:
In one example, SN CU may not be required to know or have information regarding the content of the forwarding signal. In this example, the SN CU may not process the forwarding signal (e.g., decode, detect, demodulate, correlation operation, etc.). The energy measurement may be based on the energy of all signals (e.g., forwarding signals, interference, etc.) at the reception point (e.g., input of the SN FU) and/or relevant noise, similar to RSSI measurement. In this example, the SN 306 (e.g., SN CU) can measure the energy value of all signals at the input of the SN FU.
In another example, SN CU may be aware of or have information regarding the forwarding signals. The SN CU can have the ability of processing the forwarding signals such that the energy measurement can be based on the energy of forwarding signals, e.g., similar to RSRP and/or RSRQ measurement. In this example, the SN 306 can measure the energy value of a specific signal (e.g., RSRP and/or RSRQ measurement) at the input of the SN FU.
In further example, SN CU may be aware of or have information regarding the forwarding signals. The SN CU can have the ability of or be configured for processing the forwarding signals, such that the energy measurement can be based on the energy of forwarding signals. In this case, other energy at the input of SN FU can be regarded as interference and noise. Subsequently, SN CU can calculate/compute the signal-to-interference plus noise ratio. In this example, the SN 306 can measure the signal-to-interference plus noise ratio (SINR) at the input of the SN FU.

### Example Implementation 4: The Forwarding Signal for Measurement Comprises at Least One of Existing RS, New RS, and/or Dedicated Sequence

In some implementations, the forwarding signal for measurement may include at least one of an existing reference signal (RS), new reference signal, and/or dedicated sequence. The content of the DL forwarding signal for measuring interference can include at least one of:
Existing RS: e.g., SSB, CSI-RS, etc.;
Physical downlink control channel (PDCHH) and/or physical downlink shared channel (PDSCH), among other DL signals dedicated for the SN 306;
New RS: e.g., NCR RS, to measure the corresponding interference value; and/or
Dedicated sequence (e.g., sequence dedicated for the SN 306), e.g., on-off-keying (OOK) sequence, zadoff-chu (ZC) sequence, and/or pseudo-noise (PN) sequence, among others.

The content of UL forwarding signal for measuring interference can include at least one of:
Existing RS: e.g., sounding reference signal (SRS), among other signalings;
Physical uplink control channel (PUCCH) and/or physical uplink shared channel (PUSCH), among other UL signals dedicated for the SN 306;
New RS: e.g., NCR RS, to measure the corresponding interference value; and/or
Dedicated sequence, e.g., OOK sequence, ZC sequence, PN sequence, physical random access channel (PRACH) sequence, etc.

### Example Implementation 5: Triggered Events Defined for When to Perform the Measurement

In some implementations, one or more triggered/triggering events/indications may be defined/configured for the SN 306 to determine when to perform/initiate/proceed with the measurement of the interference. For example, the SN 306 can initiate or perform the measurement of the energy value of the input signal at the input of the SN FU responsive to at least one of the following triggering events, which can be defined for SN CU:
1) Radio resource control (RRC) establishment (e.g., an event associated with the establishment of RRC connection):
   a. When SN CU decides/determines to establish RRC connection, SN CU may measure the interference.
   b. The measurement may occur/happen/initiate before the PRACH procedure and/or after the SN CU enters RRC connected state.
2) An indication from the BS 102 to perform measurement (e.g., reception of a defined indication from the BS 102):
   a. For example, the BS 102 may transmit/send/provide/communicate/signal an indication for the SN 306 to perform measurement. The BS 102 can determine to perform the transmission if the BS 102 identifies/finds that there is a problem of/with UE transmission (e.g., signals from the UE 104) according to at least one of:
      i. The re-transmission number of PUSCH and/or PUCCH is larger than K (e.g., predefined in the specification or configured by the BS 102).
      ii. The RSRP/RSRQ for PRACH signal being less than a threshold (e.g., predefined or configured via the BS 102).
   b. In another example, BS 102 may determine to transmit an indication for the SN 306 to perform measurement if the SN 306 transmits a status report including an indication of abnormality of the SN 306:
      i. The abnormality may include at least one of: beam failure, radio failure, overheating, etc.
      ii. The abnormality may include at least one of: SN CU and SN FU, and it's identified by SN CU.
   c. The indication may be transmitted in at least one of DCI and/or MAC CE.
      i. In some examples, DCI and/or MAC CE can configure one or more measurement resources.
      ii. Each measurement resource can include at least one of resource ID/index, reference SCS, start PRB, number of PRBs, start symbol in a slot (or symbol offset), duration, number of symbols, number of slots, periodicity, slot offset (periodicity and offset may be combined into single parameter), and/or reference cell index (e.g., serving cell index).
      iii. The start time of the measurement can be determined by slot n when SN CU received the DCI carrying measurement configuration and the scheduling offset k.
         1. For example, k can be included in DCI.
         2. In another example, k can be a value determined by the capability of the SN 306.
         3. In yet another example, k can be a pre-defined value, such as 0.
      iv. The start time of the measurement can be determined by n+k+slot offset, where the slot offset can be configured in RRC and/or DCI, among other types of signalings.
   d. If the indication includes at least one of time domain resource and/or frequency domain resource, the SN 306 can perform the measurement at the corresponding time and/or frequency domain resource.
   e. If the indication does not include at least one of the time domain resource and/or frequency domain resource, the SN 306 can perform the measurement after a certain (e.g., predefined/predetermined) duration:
      i. The certain duration may be predefined in the specification, such as a slot, a frame, a sub-frame, 1 ms, 5 ms, etc.
      ii. The certain duration may be the same as the measured signal length, e.g., when the measured signal is SSB, the duration can be the length/duration of the SSB signal.
3) Triggered by a signal from the UE 104 (e.g., reception of a defined indication from the UE 104):
   a. The re-transmission number of PUSCH or PUCCH may be larger than K to trigger the measurement.
   b. The signal can be an SRS signal dedicated to/for triggering the measurement.
   c. The signal can be a PRACH signal dedicated to triggering the measurement.
      i. For example, a dedicated preamble can be used to trigger the measurement.
      ii. In another example, a dedicated PRACH resource including at least one of time domain resource and/or frequency domain resource can be used to trigger the measurement.
   d. The signal can be a PUCCH signal dedicated to triggering the measurement.
      i. For example, the signal can include or correspond to an uplink control information (UCI) carrying HARQ-ACK information.
      ii. In another example, the signal can include a UCI carrying scheduling request (SR) information.
      iii. In further example, the signal can include a UCI carrying CSI report information.
   e. The signal can be a PUSCH signal dedicated to triggering the measurement.
      i. For example, the signal can include a UCI multiplexing in PUSCH.
      ii. In another example, the signal can be or include a MAC CE.
   f. The start time of measurement can be determined by the slot when SN 306 receives the signal from the UE 104 and an offset value.
      i. For example, the offset value can be configured by BS 102 carried in DCI.
      ii. In another example, the offset value can be based on the capability of the SN 306.
      iii. In further example, the offset value can be pre-defined in the specification.
4) The SN 306 may detect that at least one condition of, but are not limited to, the following conditions has been met to initiate the measurement:
   a. The RSRP/RSRQ/SINR for SSB signal may be less than a threshold.
   b. The RSRP/RSRQ/SINR for CSI-RS signal may be less than a threshold.
   c. The RSRP/RSRQ/SINR for PRACH signal may be less than a threshold.
   d. The RSRP/RSRQ/SINR for SRS signal may be less than a threshold.
   e. The RSRP/RSRQ/SINR for dedicated sequence of SN may be less than a threshold.
   f. The RSSI measurement result may be less than a threshold.
5) The SN 306 can autonomously/automatically perform the measurement responsive to detecting an anomaly (e.g., if any abnormality of/on/in the SN 306 occurs):
   a. The abnormality may include at least one of: beam failure, radio failure, overheating, etc.
   b. The abnormality may include at least one of SN CU and/or SN FU, identified by SN CU, for example.

### Example Implementation 6: Threshold Defined to Compare with the Calculated Interference Value or Measurement Result

In various implementations, one or more thresholds can be defined or configured for comparison with the calculated interference value or measurement result. The SN 306 can compare the calculated interference value or measurement result, as described in conjunction with example implementation 1, to/with at least one threshold. For example, if the interference value is greater/larger than or equal to the threshold, the SN 306 can determine that an interference issue is encountered. In another example, if the interference value is calculated per beam pair, such as described in conjunction with example configuration 6 of the example implementation 1, if the interference value is larger than (or equal to) the threshold, the SN 306 may determine that the corresponding beam pair is invalid or erroneous. For example, if the interference value or measurement result is greater/larger than or equal to the threshold, the SN 306 can determine to send the interference status report (or measurement report) to the BS 102. In another example, if the interference value or measurement result is greater/larger than or equal to the threshold, SN CU may autonomously/automatically adjust the beam, power, and/or ON-OFF of SN FU.

In some implementations, one or more sets of thresholds may be defined according to respective types or sets of interference measurement. In each set, one or more thresholds may be defined to determine the different values of interference. For example, a first set (e.g., set 1) can be for example configuration 1 of example implementation 1, and a second set (e.g., set 2) can be for example configuration 2 of example implementation 1, etc. In each set, different values of thresholds (e.g., different thresholds) may be used to determine the different level of interference as shown in the examples herein.

In some implementations, the one or more thresholds can include a respective threshold for DL forwarding (e.g., first threshold) and/or UL forwarding (e.g., second threshold). For instance, the thresholds for UL forwarding and DL forwarding may be the same or have different threshold values.

For example, one/a single threshold may be provided:

TABLE 1

| Interference | |
|---|---|
| level | |
| 0 | E < Threshold 1 |
| 1 | Threshold 1 < E |

The example Table 1 may be separately or uniformly defined for DL forwarding and/or UL forwarding. In this example, interference level 0 can represent or indicate that there is no interference issue and/or that the corresponding beam pair is valid. The interference level 1 can represent or indicate that there is an interference issue and/or the corresponding beam pair is invalid.

In another example, multiple single thresholds can be provided for each set:

TABLE 2

| | Set 1 | Set 2 |
|---|---|---|
| Interference | (for example | (for example |
| level | configuration 1) | configuration 2) |
| 0 | E < Threshold 1 | E < Threshold 2 |
| 1 | Threshold 1 < E | Threshold 2 < E |

In example Table 2, the table may be separately or uniformly defined for DL forwarding and/or UL forwarding. In this example, interference level 0 may represent no interference issue and/or the corresponding beam pair is valid. The interference level 1 may represent or indicate that there is an interference issue and/or the corresponding beam pair is invalid.

In yet another example, multiple thresholds (e.g., three thresholds or a range of thresholds) can be provided for each set (e.g., two or more bits for each interference level):

TABLE 3

| Interference | | |
|---|---|---|
| level | Set 1(Solution 1) | Set 2(Solution 2) |
| 00 | E < Threshold 1 | E < Threshold 4 |
| 01 | Threshold 1 < | Threshold 4 < |
| | E < Threshold 2 | E < Threshold 5 |
| 10 | Threshold 2 < | Threshold 5 < |
| | E < Threshold 3 | E < Threshold 6 |
| 11 | E > Threshold 3 | E > Threshold 6 |

In example Table 3, the table may be separately or uniformly defined for DL forwarding and/or UL forwarding. In this example, the severity of an interference issue can be 00<01<10<11, for example.

In various implementations, the one or more thresholds may be at least one of:
Predefined in the specification;
Indicated or configured by the BS 102; and/or
Dependent on, up to, or defined according to the capability of the SN 306.

### Example Implementation 7: SN CU Transmits a Report to BS

In various arrangements, the SN 306 (e.g., SN CU) can transmit/provide/send a report (e.g., an indication) to the BS 102 indicating the interference status which can include at least one of measurement result, interference value, interference level, UL/DL information, action information and/or beam information. The report can have/include at least one of the following report types: periodical, and/or event-triggered. The configuration of the report can be transmitted by BS 102 to SN 306 in RRC signals or system information. In some implementations, the configuration of the measurement and/or report can be transmitted to SN 306 in the same signal, e.g., in different information elements (IE) of the same RRC message. The configuration can include at least one of the following parameters:
Threshold, the value of the threshold to define the entering and/or leaving condition of the event.
Report interval can be used to indicate the time interval between adjacent reports. This parameter can be used for periodical and/or event-triggered report.
The triggered event can define or represent the entering/triggering/initiating condition and/or leaving/exiting condition to determine whether to send a report.
   After the entering condition is satisfied/met until the leaving condition is satisfied, SN CU can transmit a measurement report for every reporting interval.
      For example, the entering condition can be interference value or measurement result+H>threshold, where H can be the hysteresis value configured in RRC.
   When the leaving condition is satisfied/met, SN CU may transmit a measurement report if the value of the parameter “reportOnLeave” is TRUE (e.g., 1).
A Hysteresis can be used within the entry and/or leave condition of an event-triggered reporting condition.
Report on leave can indicate whether or not the UE 104 is to initiate the measurement reporting procedure when the leaving condition is met/satisfied.
Time to Trigger can specify the value range used for the time to trigger parameter, which can involve or indicate the time during which specific criteria for the event may be met to trigger a measurement report.
Report type can indicate one or more types of report, e.g., periodical, event triggered, etc.
Measurement method type can indicate the method for measurement (e.g., example configurations), which may be referred to or called report quantity, e.g., RSRP, RSRQ, RSSI, SINR, etc.
Reference signal type can indicate the reference signal type used for measurement, e.g., SS/PBCH block (SSB), CSI-RS, SRS, PRACH, etc.
Report amount can correspond to the number of measurement reports applicable for event triggered and/or for periodical report types.
Maximum number of measurement resources in a measurement report.

The content/information/details of the report can include at least one of:
1) Measurement result:
   a. For example, in example configuration 1 of example implementation 1, P1 and/or P2 can represent the measurement results, which may be regarded as or include raw data measured by the SN 306 (e.g., SN CU). The interference value can be calculated or determined based on these measurement results (e.g., P1 and/or P2). The one or more measurement results may be referred to as one or more values measured by the SN 306.
   b. In some implementations, this measurement result can represent a physical layer measurement result, e.g., L₁ result.
2) Interference value (e.g., value of interference):
   a. For example, in example configuration 1 of example implementation 1, (P2−P1)/P1 or α*(P2−P1)/P1 can be regarded as an interference value, which can be calculated based on one or more measurement results (e.g., P1 and/or P2).
   b. In some implementations, this interference value can represent a higher layer measurement result, e.g., L3 result.
3) The interference level after or based on a comparison between the measurement result or interference value with at least one threshold:
   a. For example, the result can include 1 bit to indicate the interference level. In this case, if the interference value is larger than (or equal to) the threshold, bit “0” may be used to represent that the SN 306 has an interference issue. Otherwise, bit “1” may be used to represent that there is no interference issue.
   b. In another example, the result can include 1 bit to indicate the interference level. In this case, if the interference value is larger than (or equal to) the threshold, bit “1” can be used to represent that the SN 306 has an interference issue. Otherwise, bit “0” can be used to represent that there is no interference issue.
   c. In yet another example, the result can include N bits, where each bit can be used to indicate the interference level for at least one beam pair. In this case, if the interference value per beam pair is larger than (or equal to) the threshold, bit “0” can be used to represent that the corresponding beam pair has an interference issue, thereby indicating that the beam pair is invalid. Otherwise, bit “1” can be used to represent that the corresponding beam pair has no interference issue, thereby indicating that the beam pair is valid.
   d. In further example, the result can include N bits, where each bit can indicate the interference level for at least one beam pair. In this case, if the interference value per beam pair is larger than (or equal to) the threshold, bit “1” can be used to represent that the corresponding beam pair has an interference issue, thereby indicating that the beam pair is invalid. Otherwise, bit “0” can be used to represent that the corresponding beam pair has no interference issue, thereby indicating that the beam pair is valid.
4) UL/DL information:
   a. For example, the interference measurement may be performed only in DL forwarding. Due to the mutuality, the interference level or value may be applied to both UL forwarding and DL forwarding.
   b. In another example, the interference measurement may be performed only in UL forwarding. Due to the mutuality, the interference level or value may be applied to both UL forwarding and DL forwarding.
   c. In yet another example, the interference measurement may be performed separately in UL forwarding and DL forwarding. In this case, the interference level or value can be stored for both UL forwarding and DL forwarding.
5) Action information:
   a. For example, the SN 306 may perform a beam adjustment operation after/subsequent to the measurement (e.g., interference measurement). In this case, the SN 306 can report the relevant action information (e.g., an indication of the beam adjustment operation performed by the SN 306 responsive to the measurement) to the BS 102.
   b. In another example, the SN 306 may perform an ON-OFF adjustment operation after the measurement. In this case, the SN 306 may report the relevant action information (e.g., an indication of the ON-OFF adjustment operation) to the BS 102.
   c. In yet another example, the SN 306 may perform a power/gain adjustment operation after the measurement. In this case, the SN 306 may report the relevant action information (e.g., power/gain adjustment operation) to the BS 102.
6) Beam information:
   a. For example, according to the at least one of measurement result, interference value and/or interference level, if the beam pair (x, y) has an interference issue, SN CU may report the information of beam pair (x, y) to the BS 102, such that the BS 102 may not allocate or avoid allocating the SN 306 to use the beam pair (that caused interference).
7) Power information:
   a. For example, according to at least one of the measurement result, interference value, and/or interference level, if the configured power value has an interference issue, SN CU may report the information of power value to the BS 102, such that the BS 102 may reduce the power of SN 306 (e.g., SN FU) to avoid the interference.
   b. In another example, according to at least one of the measurement result, interference value, and/or interference level, SN CU may report one or more of the configured power values associated with the at least one of the measurement result, interference value, and/or interference level to the BS 102.

The report can be transmitted by the SN 306 to the BS 102 via at least one of the following:
In uplink control information (UCI) via PUCCH;
In UCI via PUSCH;
In medium access control control element (MAC CE) via PUSCH; and/or
In RRC message via PUSCH, e.g., in uplink dedicated control channel (UL-DCCH) message via DCCH logical channel in PUSCH.

### Example Implementation 8: SN CU Reacts According to Interference Status

In some implementations, the SN 306 (e.g., SN CU) may receive/obtain/acquire an indication from the BS 102 to react/respond/perform an action according to the interference status. The indication from the BS 102 can be a response to the BS 102 receiving the report. For instance, the BS 102 may react according to the interference status report, and at least one of the following indications may be received by SN CU:
1) SN CU may receive a beam indication to configure the beam index of/for the forwarding link according to the interference value report, e.g., BS 102 can avoid/avert configuring the beam index pair with the interference issue.
   a. In this case, the beam indication may include an associated time domain resource.
   b. After receiving the indication, the SN 306 may adjust the beam pair according to the indication.
   c. After receiving the indication, SN CU may turn off, disable, or configure an “OFF” state for the SN Fwd (e.g., SN FU) within the indicated time domain resource.
2) SN CU may receive a power control indication to adjust the amplifying gain (and/or transmission power, power offset, etc.) of SN FU, in order to alleviate/minimize/reduce the overall interference value.
   a. The power indication may include an associated time domain resource.
   b. After receiving the indication, the SN 306 may adjust the overall amplifying gain (and/or transmission power, power offset, etc.) of SN FU to alleviate the interference value according to the indication from the BS 102. The SN 306 may perform the adjustment for least one of:
      i. Within the indicated time domain resource; and/or
      ii. Until SN CU received the next/subsequent/another indication.
3) SN CU may receive a power control indication to adjust the beam-specific amplifying gain (and/or transmission power, power offset, etc.) of SN FU to alleviate the interference value for the dedicated beam pair.
   a. For example, after receiving the indication, the SN 306 may adjust the beam specific amplifying gain (and/or transmission power, power offset, etc.) of SN FU to alleviate the interference value if one or more specific beam pairs have interference issues.
4) SN CU may receive an ON-OFF indication from the BS 102 to avoid performing forwarding with the interference issue.
   a. The ON-OFF indication (e.g., activate/enable or deactivate/disable at least one of the forwarding link from the SN FU) may include an associated time domain resource (e.g., when to enable and/or disable, the duration to enable and/or disable, etc.).
   b. After receiving the indication, the SN 306 may turn on or off at least one of the forwarding links, and at least one of:
      i. For specific beam pairs;
      ii. For specific frequency resources, e.g., band, carrier, BWP;
      iii. Without specific beam pairs;
      iv. Without specific frequency resource;
      v. Until SN CU receives the next indication; and/or
      vi. Within the indicated time domain resource.

### Example Implementation 9: SN Autonomously Performs Actions

In various implementations, the SN 306 may automatically/autonomously perform one or more actions according to or based on the interference measurement results, which may include at least one of the following:
SN CU may autonomously adjust the beam pair configured by the BS 102 if the configured beam pair has an interference issue.
   For example, if beam pair (x, y) has an interference issue, the beam x or y can be automatically adjusted to another beam, thereby ensuring that there is no interference issue.
SN CU may autonomously adjust the overall amplifying gain (and/or transmission power, power offset, etc.) of SN FU to alleviate the interference value.
   For example, if the SN FU (e.g., NCR Fwd) has an interference issue (e.g., interference issue is detected or determined), the amplifying gain (and/or transmission power, power offset) may be automatically minus a value (e.g., reduced by the value responsive to detecting the interference issue). The value can be predefined in the specification or configured by the BS 102.
SN CU may autonomously adjust the beam-specific amplifying gain (and/or transmission power, power offset, etc.) of SN FU to alleviate the interference value if one or more specific beam pairs have interference issue(s).
   For example, if the beam pair (x,y) has an interference issue, the amplifying gain of the beam pair (x,y) for forwarding can be automatically minus a value (e.g., the amplifying gain can be reduced by the value). The value can be predefined in the specification or configured by the BS 102.
   For example, if all the beam pairs of Tx beam 1 (e.g., the first transmission beam) have an interference issue, such as for any x, beam pair (1, x) has an interference issue, the amplifying gain of beam 1 for Tx forwarding can be automatically minus a value. The value can be predefined in the specification or configured by the BS 102.
SN CU may autonomously turn on or off (e.g., enable/activate or disable/deactivate) at least one of the forwarding links to alleviate the interference to another SN (e.g., network node) or device responsive to detecting the interference issue.
   For example, if the beam pair (x,y) has an interference issue, SN CU may deactivate/turn off one of the forwarding links of SN FU, e.g., temporarily terminate/stop/halt the forwarding. The duration for deactivating the forwarding link can be until the SN 306 receives another beam indication that has no interference issues and/or receives the power indication to reduce the amplifying gain, based on a timer, among others.

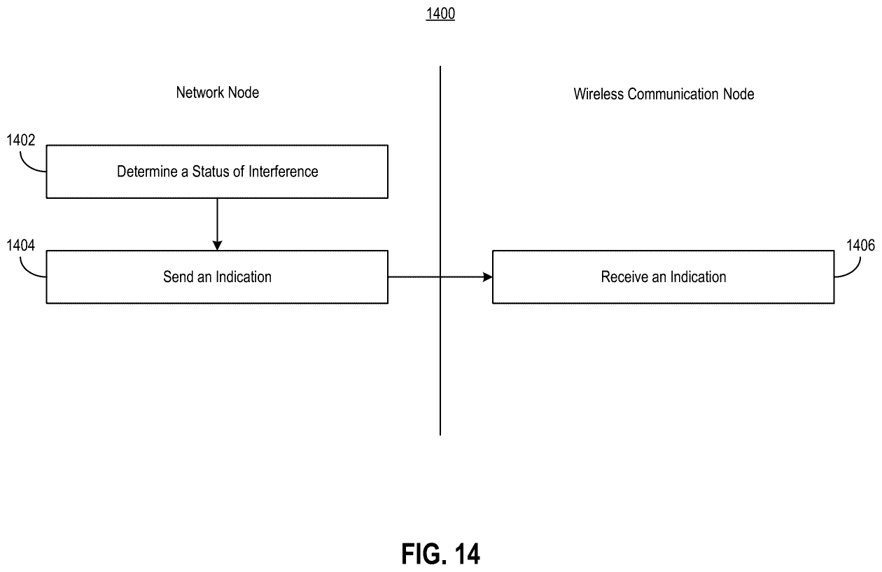

Referring now to FIG. 14 illustrates a flow diagram of a method 1400 for interference measurement for network nodes (e.g., SNs). The method 1400 may be implemented using any of the components and devices detailed herein in conjunction with FIGS. 1-13. In overview, the method 1400 may include determining a status of interference (1402). The method 1400 can include sending an indication (1404). The method 1400 can include receiving an indication (1406).

At operation (1402), and in some arrangements, a network node (e.g., SN) can determine/identify a status of interference experienced at the network node. At operation (1404), the network node can send/transmit/provide/signal/communicate an indication (e.g., report of the measured (self-) interference) of the status of the interference to a wireless communication node (e.g., BS, Gnb, Enb, or TRP). At operation (1406), the wireless communication node can receive/obtain/acquire the indication of the status of interference from the network node.

In some implementations, the interference may be experienced by at least one of: the control link between the wireless communication node and the network node; the backhaul link between the wireless communication node and the network node; and/or the access link between a wireless communication device (e.g., UE) and the network node.

In some configurations, determining the status of the interference can include at least one of: the network node measuring/determining a first energy value (P1) at an input (e.g., point A (or point B) of the network node, when a first link (e.g., F2 link or F3 link depending on DL or UL forwarding) to the input is activated/turned on/enabled, and a second link (e.g., F4 link or F1 link) from an output of the network node is deactivated/turned off/disabled; the network node measuring a second energy value (P2) at the input of the network node, when the first link to the input is activated, and the second link is activated; and/or the network node determining a value of the interference as a function of at least one of: P1, P2, or α. The value α can be a positive value (e.g., greater than 0) configured by the wireless communication node.

In some configurations, determining the status of the interference can include at least one of: the network node measuring a respective energy value at an input (e.g., point A or point B) of the network node, for each of a plurality of power values when a first link (e.g., F2 link or F3 link) to the input is activated and a second link (e.g., F4 link or F1 link) from an output of the network node is activated; and/or the network node determining a value of the interference as a function of at least one of: one or more of the respective energy values, one or more of the plurality of power values, or α, where α is a positive value configured by the wireless communication node. In some implementations, at least one of: each of the plurality of power values may refer to or represent at least one of: an amplifying again, a transmission power, and/or a power offset, etc., for the network node.

In some configurations, determining the status of the interference can include at least one of: the network node measuring a respective energy value at an input (e.g., point A or point B) of the network node, in each of various time windows when a first link (e.g., F2 link or F3 link) to the input is activated and a second link (e.g., F4 link or F1 link) from an output of the network node is activated; and/or the network node determining a value of the interference as a function of at least one of: one or more of the respective energy values, or a. The value α can be a positive value configured by the wireless communication node.

In some implementations, the time windows can include at least one of: a first time window that may be defined from a first time instance (e.g., T0) to a second time instance, where the second time instance can be T1 added to the first time instance; a second time window that can be defined from the second time instance to a third time instance, where the third time instance can be T2 added to the first time instance; and/or a third time window that can be defined from the third time instance to a fourth time instance, where the fourth time instance can be T1 added to the third time instance.

In some implementations, the values of T0, T1, and T2 may be determined according to at least one of: the capability of the network node; duration of the measurement; time domain resource of reference signal; a predefined value; a parameter configured by the wireless communication node; the start time of the measurement; a predefined time instance; and/or a time instance triggered by a wireless communication device.

In some configurations, determining the status of the interference can include at least one of: the network node measuring a first energy value (P1) of an input signal at an input (e.g., point A or point B) of the network node, in a first frequency band of the input signal (e.g., band 1) when a first link (e.g., F2 link or F3 link) to the input is activated, and a second link (e.g., F4 link or F1 link) from an output of the network node is activated; the network node measuring a second energy value (P2) of the input signal at the input of the network node, in a second frequency band of an output signal (e.g., band 2) corresponding to the input signal, when the first link to the input is activated, and the second link is activated; and/or the network node determining a value of the interference as a function of at least one of: P1, P2, or α, where α is a positive value configured by the wireless communication node.

In some configurations, determining the status of the interference can include at least one of: the network node measuring a first energy value (P1) of an input signal at an input (e.g., point A or point B) of the network node, at a first polarization of the input signal (e.g., polarization 1) when a first link (e.g., F2 link or F3 link) to the input is activated, and a second link (e.g., F4 link or F1 link) from an output of the network node is activated; the network node measuring a second energy value (P2) of the input signal at the input of the network node, at a second polarization of an output signal (e.g., polarization 2) corresponding to the input signal, when the first link to the input is activated, and the second link is activated; and/or the network node determining a value of the interference as a function of at least one of: P1, P2, or α, where α is a positive value configured by the wireless communication node.

In some implementations, P1 and/or P2 can be measured (e.g., by the network node) for a specific input beam at the input and a specific output beam at the output. In various implementations, at least one of: each respective energy value can be measured for a respective input beam at the input and/or a respective output beam at the output, each respective input beam may be the same as or different from another respective input beam, and/or each respective output beam may be same as or different from another respective output beam.

In some arrangements, the first link and/or the second link can include one of: a first forwarding link (e.g., F2 link) from the wireless communication node to the network node; a second forwarding link (e.g., F4 link) from the network node to the wireless communication device; a third forwarding link (e.g., F1 link) from the network node to the wireless communication node; a fourth forwarding link (e.g., F3 link) from the wireless communication device to the network node; a first control link from the wireless communication node to the network node; and/or a second control link from the network node to the wireless communication node.

In some arrangements, the network node may receive/obtain/acquire at least one parameter for interference measurement from the wireless communication node. In this case, the network node may determine the status of the interference according to the at least one parameter for interference measurement. For example, the at least one parameter can include an indication of at least one of: a time domain resource, a frequency domain resource, at least one of: a transmission power, an amplifying gain, and/or a power offset, beam information, activation or deactivation information (e.g., ON-OFF indication) for at least one of a first link or a second link, polarization information, measurement direction (e.g., UL/DL indication), which may include uplink, downlink, and/or both uplink and downlink, an indication for selection of a method for determining the status of the interference (e.g., at least one of the example configurations of example implementation 1), reference signal type (e.g., SS/PBCH block (SSB), CSI-RS, SRS, PRACH, etc.), measurement method type (e.g., RSSI, RSRP, RSRQ, SINR), cell information (e.g., serving cell index), and/or a threshold for a level of the interference.

In some implementations, the selection of a method (e.g., one of example configurations 1-6) for determining the status of the interference may be explicitly or implicitly based at least on the at least one parameter. For instance, the selection of the method may be explicitly determined by at least one parameter or implicitly determined according to or by the configuration of individual example configurations/methods. For instance, if frequency-related parameter for different bands is configured, the network node can determine an implicit selection of the example configuration 4 of example implementation 1.

In some arrangements, determining the status of the interference can include at least one of: measuring, by the network node, an energy value of all signals (and/or noise) (e.g., RSSI) at an input of the network node; measuring, by the network node, an energy value of a specific signal (e.g., RSRP/RSRQ) at the input of the network node; and/or measuring, by the network node, a strength of noise at the input of the network node (e.g., for calculating SINR).

In some arrangements, determining the status of the interference may include: the network node measuring an energy value of an input signal at an input of the network node. The input signal can include at least one of: a synchronization signal block (SSB), a channel state information RS (CSI-RS), a downlink signal dedicated for the network node, a physical downlink control channel (PDCCH) signal, a physical downlink shared channel (PDSCH) signal, a sequence dedicated for the network node, an on-off keying sequence, a Zadoff-Chu (ZC) sequence, a pseudonoise (PN) sequence, a sounding reference signal (SRS), a physical uplink control channel (PUCCH) signal, a physical uplink shared channel (PUSCH) signal, an uplink signal dedicated for the network node, and/or a physical random access channel (PRACH) sequence.

In some arrangements, determining the status of the interference can include: the network node measuring an energy value of an input signal at an input of the network node, responsive to a triggering event. The triggering event can include at least one of: an event associated with establishment of radio resource control (RRC) connection, reception of a defined indication from the wireless communication node, reception of a defined indication from the wireless communication device, the network node detecting that a condition has been met (e.g., triggered by the UE signal, such as the re-transmission number of PUSCH and/or PUCCH being larger than (or equal to) K and/or the RSRP/RSRQ for SSB/CSI-RS signal being less than a threshold), and/or the network node detecting an anomaly.

In some arrangements, the network node can compare a value of the interference with at least one threshold. The at least one threshold can at least one of: comprise a respective threshold for each type or set of interference measurement, comprise a first threshold for downlink forwarding, and a second threshold for uplink forwarding, define multiple ranges for levels of the interference, be predefined in the specification, be indicated or configured by the wireless communication node, and/or be defined according to a capability of the network node.

In some arrangements, the indication of the status of the interference (e.g., the report) sent/provided/indicated/signaled to the wireless communication node can include at least one of: a value (e.g., raw data) measured by the network node, multiple values measured by the network node, a value of the interference (e.g., a function of the raw data), calculated using at least one value measured by the network node, a level of the interference, determined according to a comparison between the value measured by the network node and a threshold, a level of the interference determined according to a comparison between the value of the interference and a threshold, an indication that the status of the interference is determined for or applies to: downlink forwarding, uplink forwarding, or both downlink forwarding and uplink forwarding, beam information according to the status of the interference, power information according to the status of the interference, and/or information about an action to be performed by the network node, after or responsive to: the status of the interference and/or a measurement by the network node. In some implementations, the network node may send indication to the wireless communication node in: uplink control information (UCI) via a transmission in physical uplink control channel (PUCCH) or physical uplink shared channel (PUSCH), medium access control control element (MAC CE) signaling via a transmission in PUSCH, and/or radio resource control (RRC) signaling via a transmission in PUSCH, among other signalings.

In some arrangements, the network node may receive a message/response from the wireless communication node in response to the indication of the status of the interference. The message can include at least one of: a beam indication to configure beam index of the forwarding link, a power control indication to adjust, specific to or not specific to a beam, at least one of: an amplifying gain, transmission power of power offset of the network node, an indication to activate or deactivate the forwarding link, and/or a time domain resource associated with the beam, power control or activation/deactivation indication. The network node may perform at least one of the following according to the message: an adjustment of a beam pair configured by the wireless communication node, an adjustment, specific to or not specific to a beam, an amplifying gain, transmission power of power offset of the network node, and/or activation or deactivation of at least one link of the forwarding link, among others.

In some arrangements, the network node may perform (e.g., autonomously/automatically) at least one of the following according to the status of the interference: adjust a beam pair configured by the wireless communication node, adjust, specific to or not specific to a beam, an amplifying gain, transmission power of power offset of the network node, and/or activate/enable or deactivate/disable at least one link of the forwarding link.

While various embodiments of the present solution have been described above, it should be understood that they have been presented by way of example only, and not by way of limitation. Likewise, the various diagrams may depict an example architecture or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, which may be referenced in the above description, can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
determining, by a network node, a status of interference experienced at the network node; and
sending, by the network node to a wireless communication node, an indication of the status of the interference.

2. The method of claim 1, wherein the interference is experienced by at least one of:
the control link between the wireless communication node and the network node;
the backhaul link between the wireless communication node and the network node; or
the access link between a wireless communication device and the network node.

3. The method of claim 1, wherein determining the status of the interference comprises at least one of:
measuring, by the network node, a first energy value (P1) at an input of the network node, when a first link to the input is activated, and a second link from an output of the network node is deactivated;
measuring, by the network node, a second energy value (P2) at the input of the network node, when the first link to the input is activated, and the second link is activated; or
determining, by the network node, a value of the interference as a function of at least one of: P1, P2, or α, where α is a positive value configured by the wireless communication node.

4. The method of claim 1, wherein determining the status of the interference comprises at least one of:
measuring, by the network node, a respective energy value at an input of the network node, for each of a plurality of power values when a first link to the input is activated and a second link from an output of the network node is activated; and
determining, by the network node, a value of the interference as a function of at least one of: one or more of the respective energy values, one or more of the plurality of power values, or α, where α is a positive value configured by the wireless communication node.

5. The method of claim 4, wherein:
each of the plurality of power values refers to at least one of: an amplifying gain, a transmission power, or a power offset, for the network node.

6. The method of claim 1, wherein determining the status of the interference comprises at least one of:
measuring, by the network node, a respective energy value at an input of the network node, in each of a plurality of time windows when a first link to the input is activated and a second link from an output of the network node is activated; or
determining, by the network node, a value of the interference as a function of at least one of: one or more of the respective energy values, or α, where α is a positive value configured by the wireless communication node.

7. The method of claim 6, wherein the plurality of time windows includes at least one of:
a first time window that is defined from a first time instance (T0) to a second time instance, wherein the second time instance is T1 added to the first time instance;
a second time window that is defined from the second time instance to a third time instance, wherein the third time instance is T2 added to the first time instance; or
a third time window that is defined from the third time instance to a fourth time instance, wherein the fourth time instance is T1 added to the third time instance.

8. The method of claim 7, wherein the values of T0, T1, and T2 are determined according to at least one of:
a capability of the network node;
duration of the measurement;
time domain resource of reference signal;
a predefined value;
a parameter configured by the wireless communication node;
a start time of the measurement;
a predefined time instance; or
a time instance triggered by a wireless communication device.

9. The method of claim 1, wherein determining the status of the interference comprises at least one of:
measuring, by the network node, a first energy value (P1) of an input signal at an input of the network node, in a first frequency band of the input signal when a first link to the input is activated, and a second link from an output of the network node is activated;
measuring, by the network node, a second energy value (P2) of the input signal at the input of the network node, in a second frequency band of an output signal corresponding to the input signal, when the first link to the input is activated, and the second link is activated; or
determining, by the network node, a value of the interference as a function of at least one of: P1, P2, or α, where α is a positive value configured by the wireless communication node.

10. The method of claim 1, wherein determining the status of the interference comprises at least one of:
measuring, by the network node, a first energy value (P1) of an input signal at an input of the network node, at a first polarization of the input signal when a first link to the input is activated, and a second link from an output of the network node is activated;
measuring, by the network node, a second energy value (P2) of the input signal at the input of the network node, at a second polarization of an output signal corresponding to the input signal, when the first link to the input is activated, and the second link is activated; or
determining, by the network node, a value of the interference as a function of at least one of: P1, P2, or α, where α is a positive value configured by the wireless communication node.

11. The method of claim 3, wherein P1 and P2 are measured for a specific input beam at the input and a specific output beam at the output.

12. The method of claim 4, wherein at least one of:
each respective energy value is measured for a respective input beam at the input and a respective output beam at the output,
each respective input beam is same as or different from another respective input beam, or
each respective output beam is same as or different from another respective output beam.

13. The method of claim 3, wherein the first link or the second link comprises at least one of:
a first forwarding link from the wireless communication node to the network node;
a second forwarding link from the network node to a wireless communication device;
a third forwarding link from the network node to the wireless communication node;
a fourth forwarding link from a wireless communication device to the network node;
a first control link from the wireless communication node to the network node; or
a second control link from the network node to the wireless communication node.

14. The method of claim 1, comprising:
receiving, by the network node from the wireless communication node, at least one parameter for interference measurement; and
determining, by the network node, the status of the interference according to the at least one parameter for interference measurement.

15. The method of claim 14, wherein the at least one parameter comprises an indication of at least one of:
a time domain resource,
a frequency domain resource,
at least one of: a transmission power, an amplifying gain, or a power offset, beam information,
activation or deactivation information for at least one of a first link or a second link, polarization information,
measurement direction, which comprises uplink, downlink, or both uplink and downlink, an indication for selection of a method for determining the status of the interference, reference signal type,
measurement method type,
cell information, or
a threshold for a level of the interference.

16. The method of claim 3, wherein selection of a method for determining the status of the interference is explicitly or implicitly based at least on the at least one parameter.

17. The method of claim 1, wherein determining the status of the interference comprises at least one of:
measuring, by the network node, an energy value of all signals at an input of the network node;
measuring, by the network node, an energy value of a specific signal at the input of the network node; or
measuring, by the network node, a strength of noise at the input of the network node.

18. A method comprising:
receiving, by a wireless communication node from a network node, an indication of a status of interference,
wherein the status of the interference is experienced at the network node.

19. A network node, comprising:
at least one processor configured to:
determine a status of interference experienced at the network node; and
send, via a transmitter to a wireless communication node, an indication of the status of the interference.

20. A wireless communication node, comprising:
at least one processor configured to:
receiving, via a receiver a from a network node, an indication of a status of interference,
wherein the status of the interference is experienced at the network node.
